(19) United States
(12) Patent Application Publication
(10) Pub. No.: US 2005/0165965 A1
(43) Pub. Date: Jul. 28, 2005

(54) Methods for communication in a multi-cluster network, device for connection to a network of clusters and bridge for connecting clusters

(76) Inventors: Jean-Baptiste Henry, Melesse (FR); Guillaume Bichot, La Chapelle Chaussee (FR); Joel Sirot, Montreuil Sur Ille (FR)

Correspondence Address: THOMSON LICENSING INC., PATENT OPERATIONS, PO BOX 5312, PRINCETON, NJ, 08543-5312, US

(21) Appl. No.: 10/510,536

(22) PCT Filed: Apr. 9, 2003
(86) PCT No.: PCT/EP03/04694

(30) Foreign Application Priority Data
Apr. 9, 2002 (EP) 02290890.9

(51) Int. Cl. G06F 15/16

(52) U.S. Cl. 709/249; 709/227

(57) ABSTRACT

Bridge device comprising at least two interfaces for interfacing respective clusters of network devices in a network wherein said bridge device comprises at least two interface portals for connecting clusters. The bridge device comprises for each portal a first software component (SDDM) for receiving from an internal client requests for device describing configuration memory data (SDD) of at least one network device, said first software component being adapted to retrieve device describing data from other devices through a function call of a similar software component in the other devices. The invention also concerns a device in a multi-clustered network, the device comprising a software component as above, as well as a device discovery method and a method for establishing a connection between devices.

The invention concerns methods for communication in a multi-cluster network, for example based on but not limited to HAVi clusters, as well as devices in such a network and bridge devices for connecting clusters.

HAVi—standing for Home Audio/Video interactive—is currently defined (version 1.1 released on May 15th, 2001) on the IEEE 1394 bus (version of 1995 enhanced by the version of 2000) and consequently inherits the limitations of IEEE 1394. One limitation is the use of a single cluster network.

Such a HAVi network is difficult to deploy over an entire house, although a home network should typically connect all devices in a home. It is desirable to connect several distinct HAVi clusters.

The PCT patent applications EP02/013175 and EP02/13179 filed on Nov. 21, 2002 filed in the name of Thomson Licensing SA concern a gateway for connecting a HAVi network to a UPnP network using a GUID proxy technique.

The present application describes bridge devices and network devices, in particular the software components that are implemented in these devices and their interaction in a multi-cluster environment.

It is to be noted that the different software components constitute independent entities and inventions in themselves and may be claimed separately from each other.

The invention concerns a bridge device comprising at least two interfaces for interfacing respective clusters of network devices in a network wherein said bridge device comprises at least two interface portals for connecting clusters, characterized in that the bridge device comprises for each portal a first software component for receiving from an internal client requests for device describing configuration memory data of at least one network device, said first software component being adapted to retrieve device describing data from other devices through a function call of a similar software component in the other devices.

According to an embodiment of the invention, the first software component is adapted to retrieve data for a remote cluster device without similar software component through a function call to a similar software component of a bridge device on the path to the remote cluster device.

According to an embodiment of the invention, the first software component is adapted to retrieve data for a device without similar software component on the same cluster as itself by issuing a medium dependent request message to the device.

According to an embodiment of the invention, the first software component is adapted to maintain at least one of:
a. a list of identifiers of first software components of other devices on the network;
b. a list of devices devoid of similar first software components, associated with respective identifiers of the nearest portals on the paths to the devices in the list.

According to an embodiment of the invention, the first software component is adapted to monitor changes in the device describing data of devices devoid of a first software component on its portals local cluster and to generate corresponding device describing data change events on the clusters connected to other portals of the bridge device.

According to an embodiment of the invention, the bridge device further comprises for each portal a second software component for interfacing the portal's other software components of the respective portal with the portal cluster's communication medium, said second software component comprising an application programmable interface of which at least certain methods are globally accessible to software components of other devices of the network, for remotely accessing the communication medium.

According to an embodiment of the invention, the globally accessible methods comprise at least one among write, read, lock, enroll, drop, indication.

According to an embodiment of the invention, the bridge device further comprises for each portal a third software component for maintaining a list of all devices on all clusters of the network.

According to an embodiment of the invention, the third software component is adapted to generate, upon detection of a change on any cluster of the network, a first event informing software components of its portal of the nature of the change.

According to an embodiment of the invention, the third software component is adapted to generate a second event for informing the third software components of other portals only of the state of the event-issuing portal's a remote device list.

According to an embodiment of the invention, the second event comprises a potentially incomplete list of remote devices compared to the event-issuing portal, i.e. devices reachable through the co-portals of the event-issuing portal.

According to an embodiment of the invention, the third software component is adapted to generate a third event for informing the third software components of all devices on the cluster that the hosting portal's remote device list is stable.

According to an embodiment of the invention, the third event comprises a complete list of remote devices compared to the event-issuing portal, i.e. devices reachable through the co-portals of the event-issuing portal.

According to an embodiment of the invention, each portal comprises a fourth software component for forwarding to co-portals event messages detected on a portal's local cluster.

According to an embodiment of the invention, each portal comprises a fifth software component for receiving, on one of the bridge's clusters, a request from a fifth software component of another device, and means for forwarding said request to fifth software elements on its other clusters, with the initial requester's identifier as source address, and for forwarding the non-concatenated responses to this request back to initial requesting device.

According to an embodiment of the invention, each portal comprises a fifth software component for receiving, on one of the bridge's clusters, a request from a fifth software component of another device, and means for forwarding said request to fifth software elements on its other clusters, wherein the source address of the forwarding portal is added as a parameter to the forwarded request by the forwarding portal, for receiving and concatenating responses to the forwarded request and for forwarding the concatenated responses to this request back to the initial requesting device.

According to an embodiment of the invention, said means for forwarding said request are adapted to use a first message type for forwarding the request to fifth software elements of bridge devices and a second message type for forwarding the request to fifth software elements of non bridge devices, wherein the identifier of the forwarding portal is a parameter in the first message and not in the second message.

According to a preferred embodiment of the invention, each portal comprises a fifth software component for receiving, on one of the bridge's clusters, a request from a fifth software component of another device, and means for forwarding said request with the initial requester's identifier as source address to fifth software elements on its other clusters, for intercepting responses to this forwarded request, for concatenating the contents of these responses and for sending a single concatenated response to the initial request back to the initial requesting device.

According to an embodiment of the invention, the bridge device comprises means for converting the transport type of packets between the communication mediums of its clusters.

According to an embodiment of the invention, each portal comprises a sixth software element for establishing connection segments on local clusters for a connection crossing the bridge upon reception of a connection establishment request from a sixth software element of another device.

According to an embodiment of the invention, the sixth software element of a portal is adapted to establish a connection on its local cluster and of informing a next portal of its local cluster to carry out the next segment establishment on the path to a connection end device.

Another object of the invention is a device for connection to a cluster in a multi-cluster network, wherein clusters are connected through bridge devices, each bridge device comprising at least two cluster interfaces, wherein each interface is considered as a network device on its respective cluster characterized in that the network device comprise a first software component for receiving from an internal client requests for device describing configuration memory data of at least a second device, said first software component being adapted to retrieve device describing data from the at least one other device through a function call of a similar software component in the at least one device.

According to an embodiment of the invention, the first software component is adapted to retrieve data for a remote cluster device without similar software component through a function call to a similar software component of a bridge device on the path to the remote cluster device.

According to an embodiment of the invention, the first software component is adapted to retrieve data for a second device without similar software component on the same cluster as itself by issuing a medium dependent request message to the second device.

According to an embodiment of the invention, the first software component is adapted to maintain at least one of:
a list of identifiers of first software components of other devices on the network;
a list of devices devoid of similar first software components, associated with respective identifiers of the nearest portals on the paths to the devices in the list.

According to an embodiment of the invention, the device further comprises a third software component for maintaining a list of all devices on all clusters of the network, wherein said third software component comprises means for retrieving remote device lists from portals connected to its local cluster, and for concatenating the remote device lists with a local cluster device list.

According to an embodiment of the invention, the third software component is further adapted to maintain in the network device list an indication of the closest portal on the path for a remote device compared to the device's own local cluster.

According to an embodiment of the invention, the device comprises a fifth software component for receiving from a local client, a request for a list of remote software elements and for forwarding said request to fifth software elements of devices of the local cluster only.

According to an embodiment of the invention, the device comprises a sixth software element including an application programmable interface for clients of the same device, adapted to receive a request for establishing a connection between a sink device and a source device, said sixth software element being adapted to determine, on the path between the source and the sink device, the portal closest to the source device on the path to the sink device, and for sending an appropriate request to that portal for establishing the connection on its local clusters and for propagating this request to other appropriate portals on the path.

Note that a portal of a bridge is also a device on its local cluster.

Another object of the invention is a method for discovering devices in a network comprising at least two device clusters and at least one bridge, wherein at least two clusters are connected by a bridge, each bridge comprising at least two interface portals for connection to respective clusters, said process comprising the steps of:
having each portal obtain a list of identifiers of its local cluster's devices;
having each portal request remote device lists from each portal of the same cluster as itself;
having each portal build its own remote device list by requesting from its co-portals the list of their local devices and of remote devices reachable through the co-portals.

According to an embodiment of the invention, the method further comprises the step of making a bridge passing to messages destined to a given device if it is on the shortest path to that device.

According to an embodiment of the invention, the shortest path is the path with the lowest number of portals to be crossed.

Another object of the invention is a method for establishing a connection between a source device and a sink device in a network comprising a plurality of device clusters connected by bridge devices, wherein each bridge device comprises interface portals for connection to clusters, said method being characterized, by the steps of:
(a) providing stream manager software elements in portals of bridges and in other bridge aware devices of the network;
(b) receiving, at the level of a stream manager software element of a device, request from a connection from local client;
(c) identifying, on the path between the sink device and the source device, the portal closest to the source device, and sending a connection request to that portal;
(d) having the portal receiving the connection request establish a segment of the connection between the source device and the portal's bridge;
(e) having the portal receiving the connection request have the next portal of its bridge on the path to the source device establish the next segment of the connection on the next portal's local cluster;
(f) identify the next bridge, if any, on the path to the sink instruct the remote portal of the next bridge on the path to the sink device to establish the appropriate segment of the connection;
(g) go to step (e) until the segment of the connection to the sink device has been established.

Other characteristics of the invention will appear in the description of a preferred embodiment of the invention. The invention is not limited to this embodiment. The embodiment will be described with the help of the following drawings.

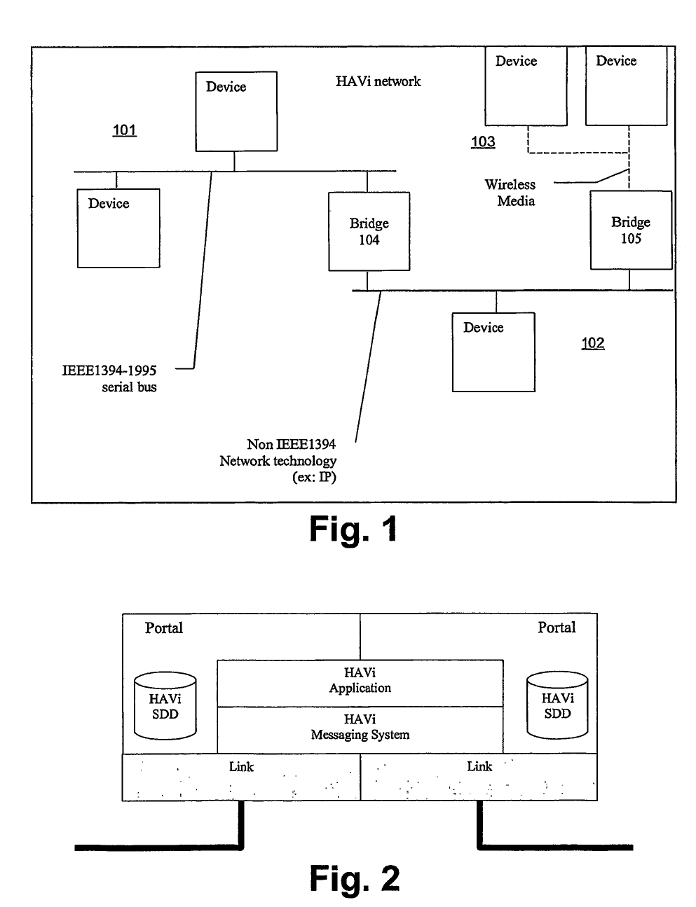

FIG. 1 is diagram of a multi-cluster HAVi network;

FIG. 2 is a diagram of a HAVi-HAVi bridge;

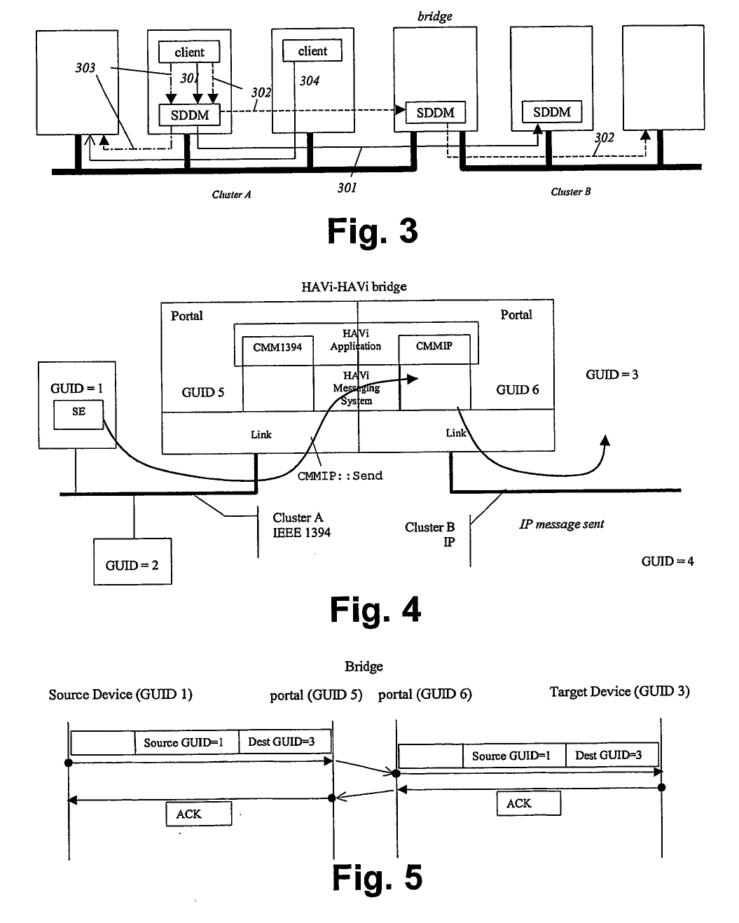

FIG. 3 is a diagram of a network illustrating the different cases of use of the SddManager;

FIG. 4 is a diagram of a multi-clustered HAVi network showing examples of use of the CMM;

FIG. 5 is a diagram illustrating the sending of a message through a bridge;

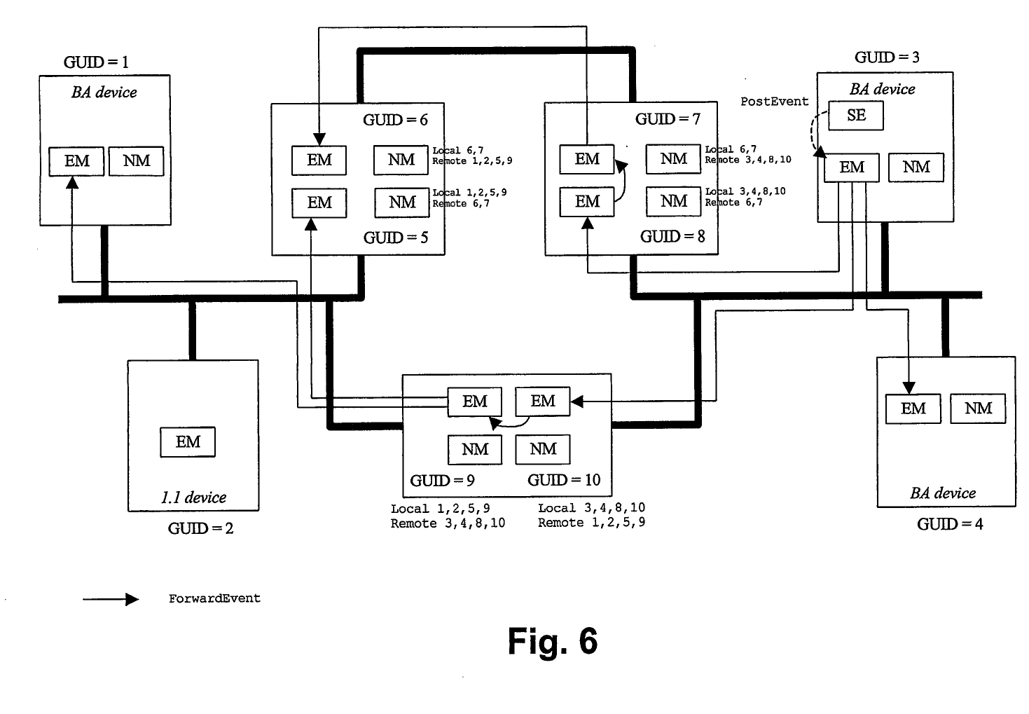

FIG. 6 is a diagram representing an event posting algorithm;

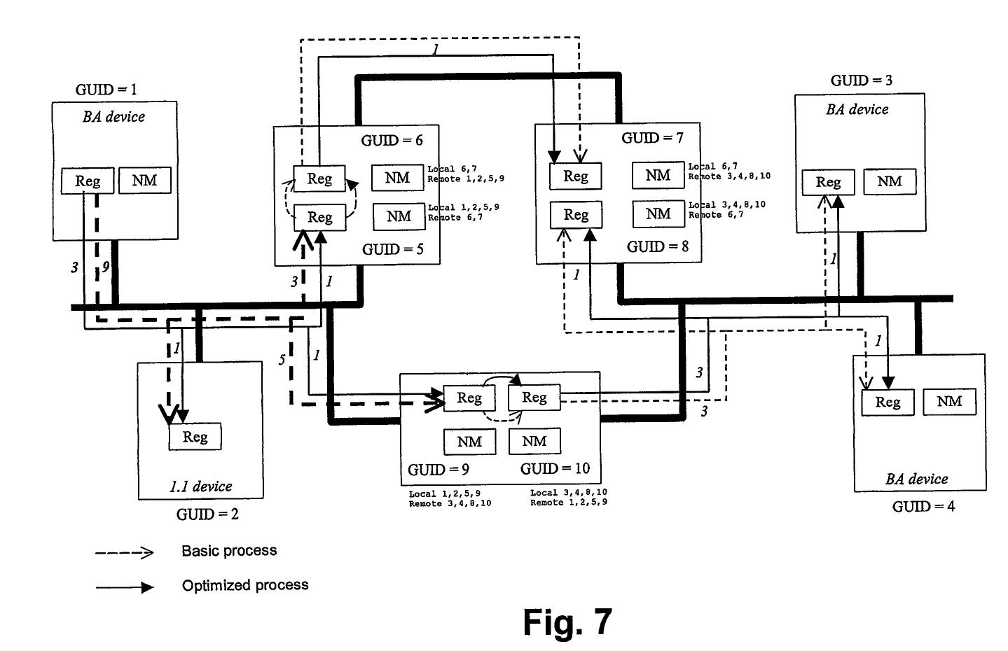

FIG. 7 is a diagram representing a traffic improvement for registries;

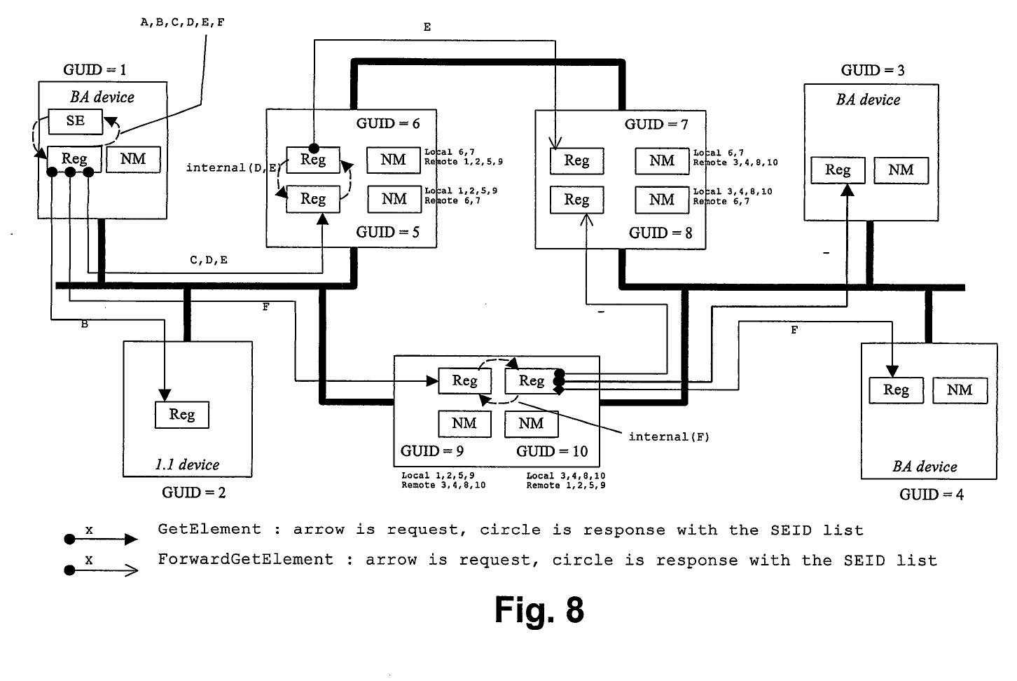

FIG. 8 is a diagram representing a request/response algorithm for bridge Registries;

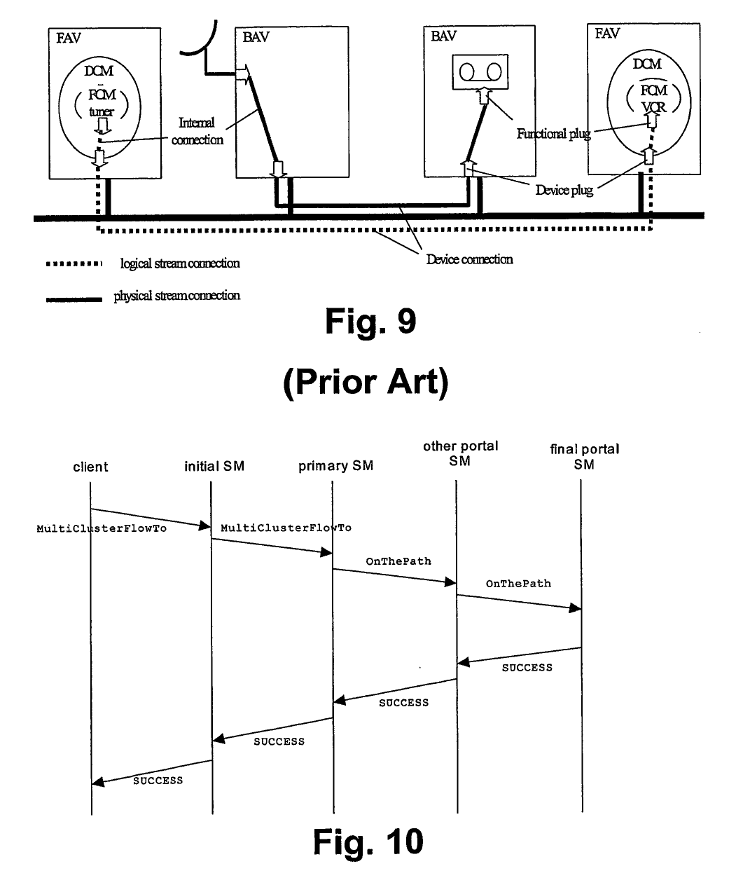

FIG. 9 is a diagram of a prior art HAVi stream connection model:

FIG. 10 is a diagram illustrating multi-clustered stream building;

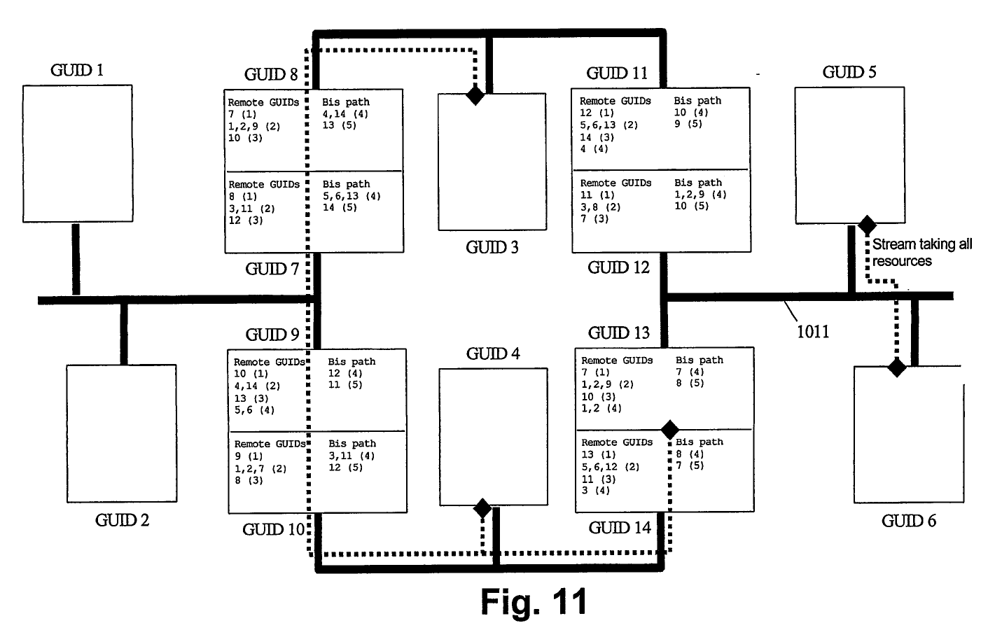

FIG. 11 is a diagram of a multi-cluster network illustrating an alternative route for data;

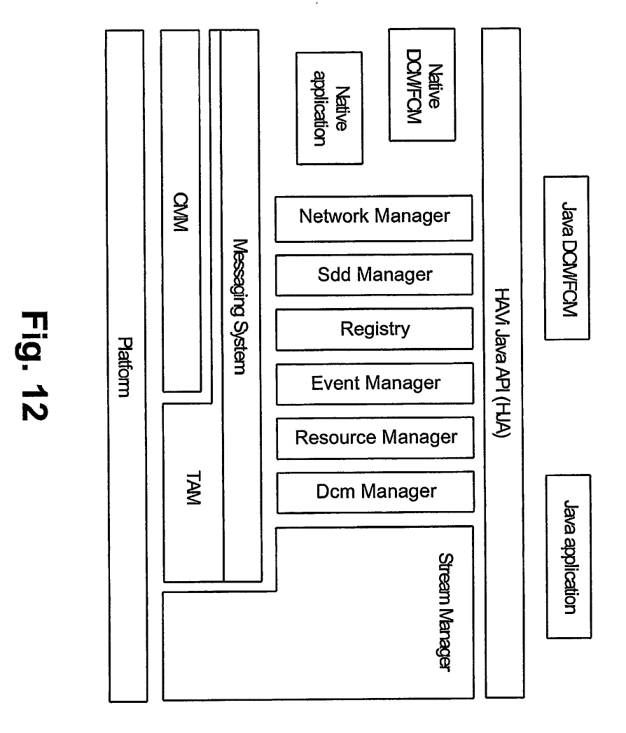

FIG. 12 is a diagram of the software architecture of a HAVi bridge aware device;

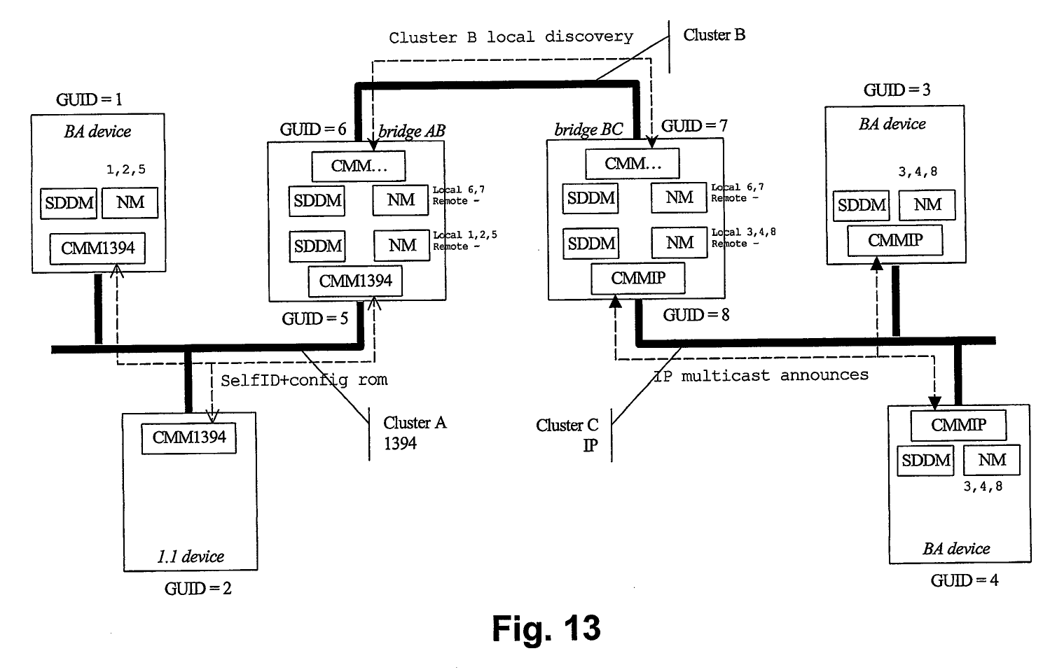

FIG. 13 is a diagram of a multi-cluster network illustrating the local discovery process

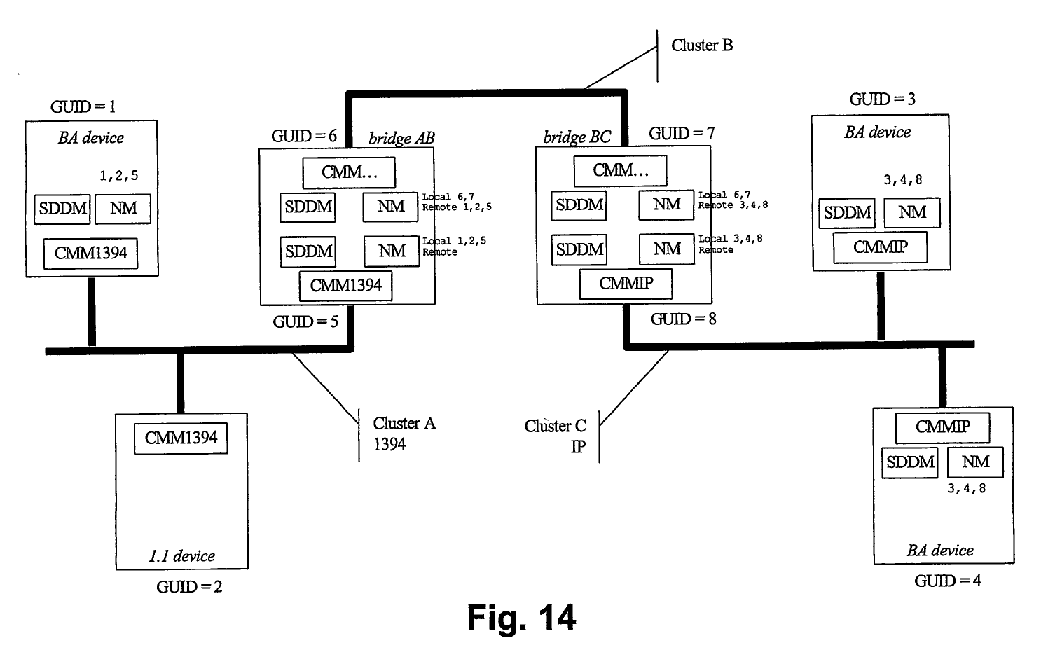

FIG. 14 is a diagram of a multi-cluster network illustrating first remote list update on leaves bridges;

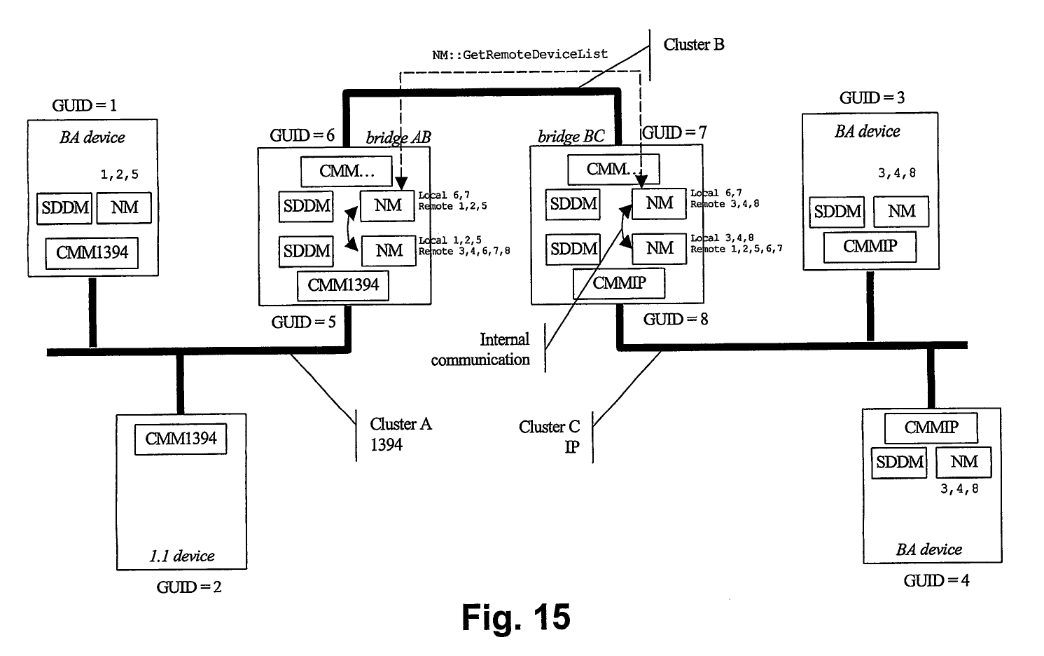

FIG. 15 is a diagram of a multi-cluster network illustrating the bridge network managers interaction;

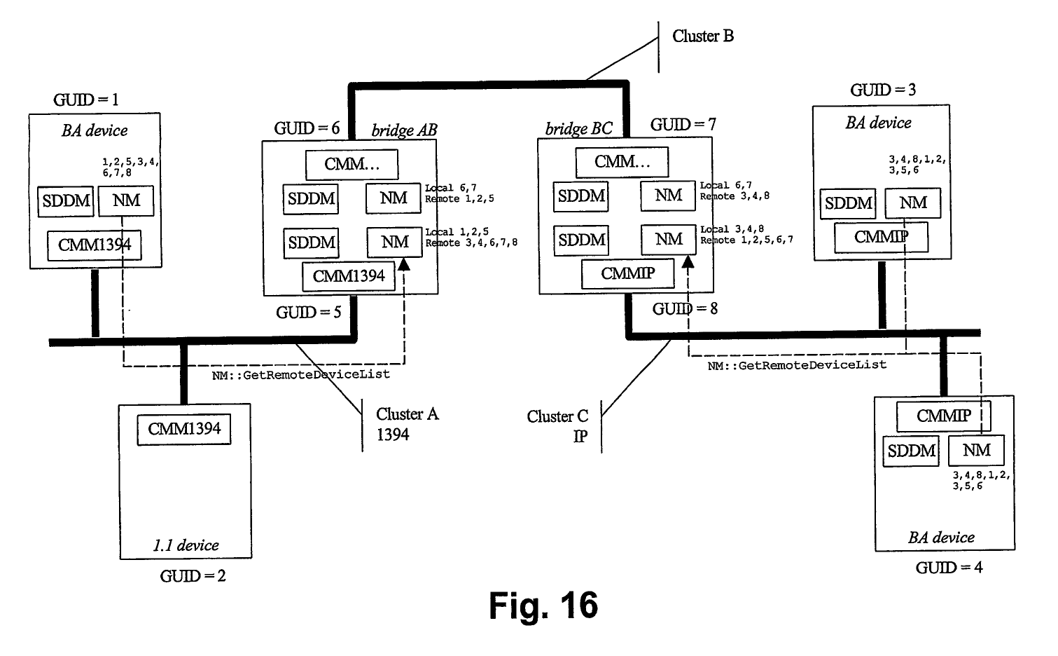

FIG. 16 is a diagram illustrating the process for building the Network Manages global list;

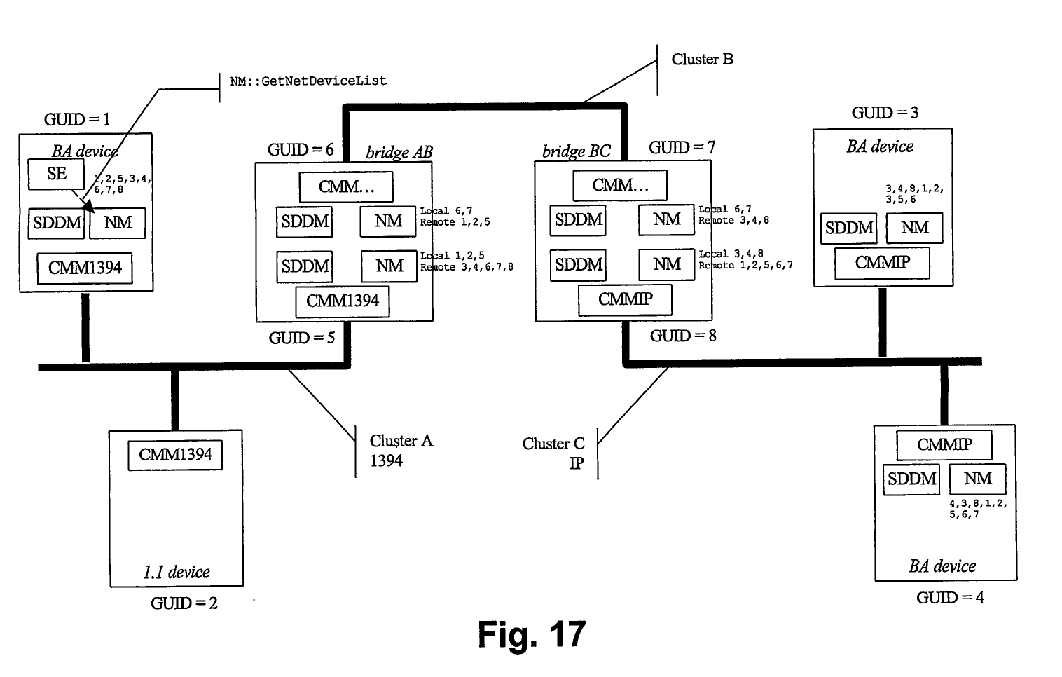

FIG. 17 is a diagram of a multi-cluster network illustrating a client call on the Network Manager;

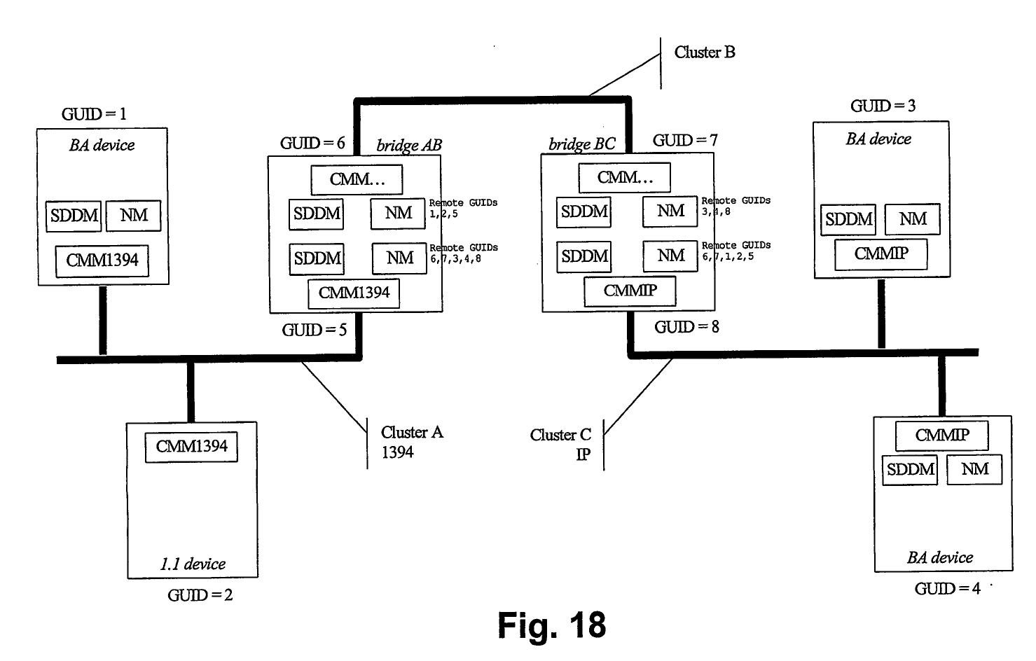

FIG. 18 is a diagram of a multi-cluster network illustrating the concept of remote lists;

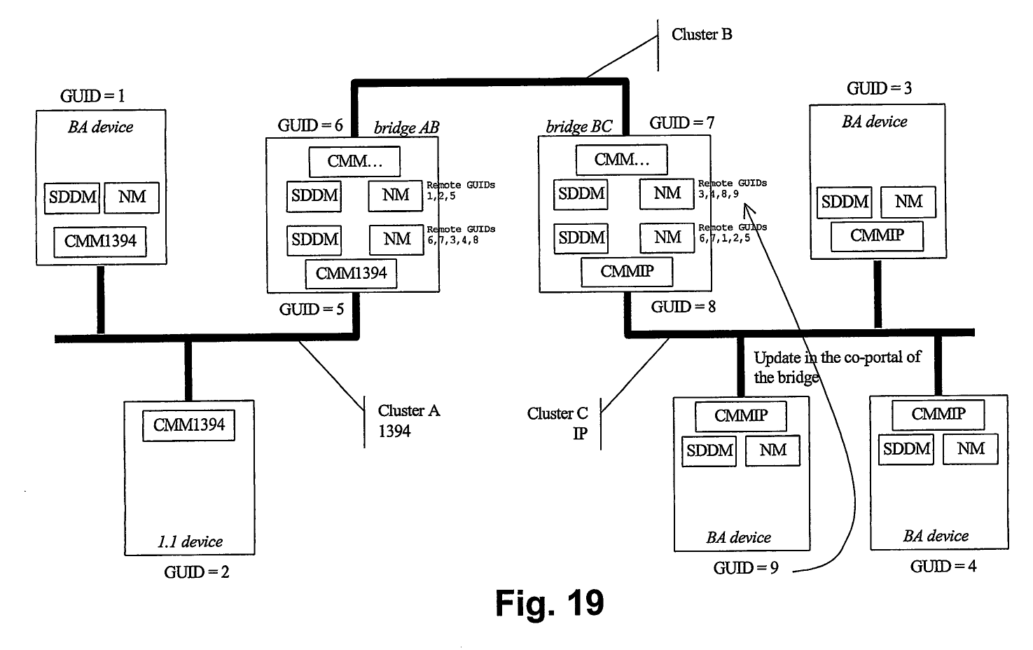

FIG. 19 is a diagram illustrating the connection of a new device;

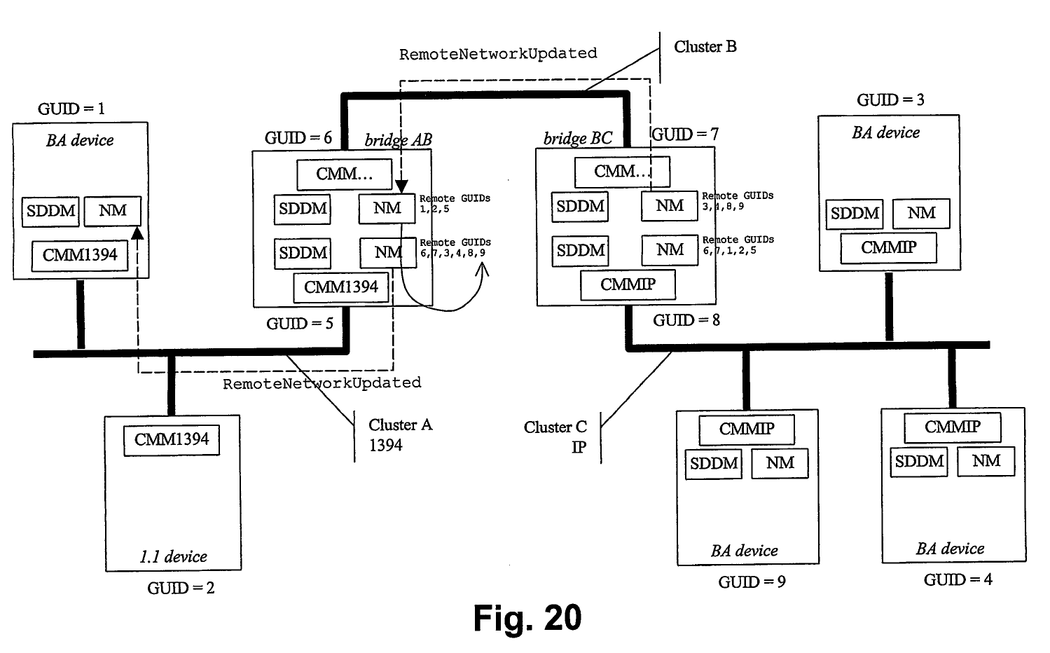

FIG. 20 is a diagram illustrating the propagation of an updated remote list;

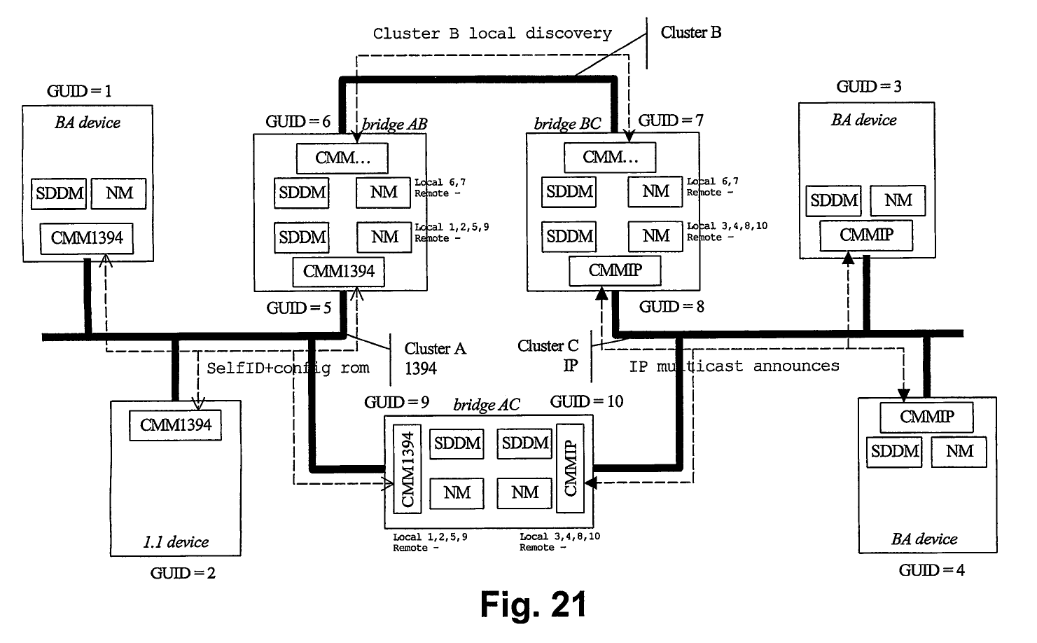

FIG. 21 is a diagram of the local discovery process in a network with a loop;

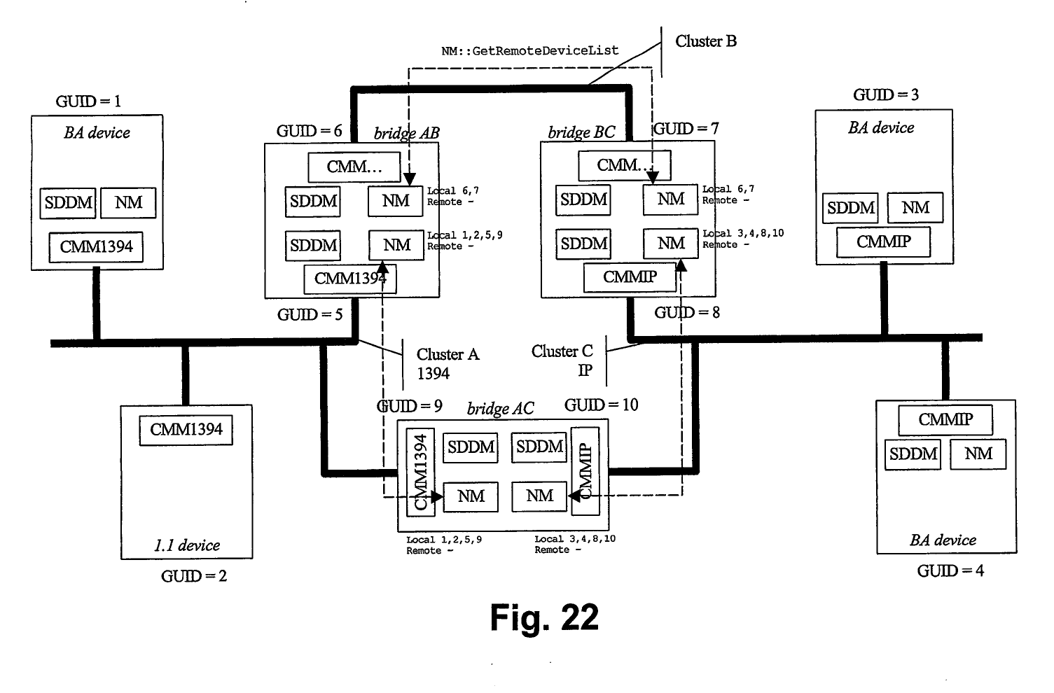

FIG. 22 is a diagram illustrating the process according to which portals request remote lists;

FIG. 2 is a diagram illustrating the process of portal update with incomplete remote lists;

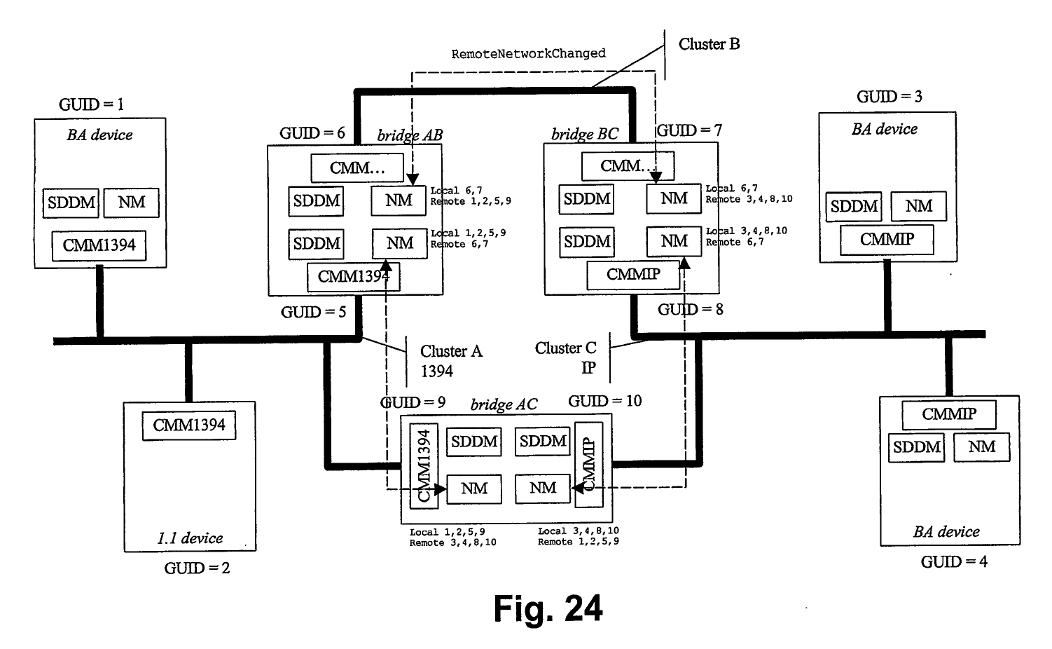

FIG. 24 is a diagram illustrating the sending of an incomplete remote list using an event;

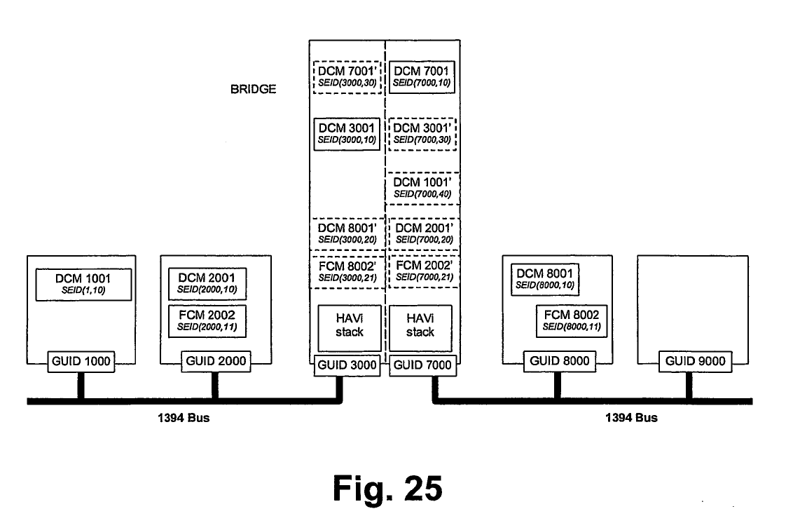

FIG. 25 is a diagram of a network comprising two HAVi clusters and a bridge using a GUID proxy technique.

One method for bridging two HAVi clusters is based on a Software Element proxy approach. FIG. 25 is an example of a network formed by two HAVi clusters linked by a bridge device. Devices and sub-devices or functions are represented by software elements, called respectively Device Control Modules (DCMs) and Functional Component Modules (FCMs).

The HAVi device discovery process is based on ‘GUID’ recognition on the IEEE 1394 bus. GUID stands for global unique identifier. A GUID uniquely identifies an IEEE 1394 device.

The devices on one side of the bridge will not be recognized by devices on the other side, because they are not visible at the IEEE 1394 level. A controller on one side will not be able to use a target on the other side. The bridge device builds representations of the DCMs and FCMs of one side to expose them as DCMs and FCMs on the other side, as proxy elements of the real Software Element they are representing.

In FIG. 25, real DCMs and FCMs are represented with their SEID (Software Element ID). The SEID is the combination of the GUID (an example being indicated at the bottom of each device) and of a number unique inside this device.

Those DCMs and FCMs are represented on the other side of the bridge by proxy SEs (Software Elements). They are shown with dashed lines to differentiate them from real SEs. There is one proxy SE for each real DCM and FCM. A controlling application can control real target devices behind the bridge through its proxy SEs.

The present embodiment of the invention will be based on portals and bridges using GUID proxies. The invention is however not limited to this particular case. Furthermore, while HAVi 1.1 is based on IEEE 1394, the clusters of the present embodiment may be based on other network technologies, and in particular on Internet Protocol (IP) or wireless technologies (IEEE 802.11, Hiperlan 2 . . . ). In the embodiment, this flexibility is achieved—as an example—by the use of the GUID proxy technique. The latest HAVi version available at the priority date of the present application is the version 1.1. HAVi 1.1 does not describe bridges, so if a HAVi 1.1 device is connected to a multi-cluster network, it will not be aware of any bridge.

The present application first describes a HAVi bridge device, followed by a description of a HAVi bridge aware device, i.e. a device being able to draw upon the bridge device's resources and to communicate with it. Such a device may be required since the bridge is not transparent to HAVi 1.1 devices.

I]The Bridge Device

FIG. 1 represents a network comprising three clusters 101 to 103, interconnected in a serial fashion by two bridges 104 and 105. Cluster 101 is based on IEEE 1394, cluster 102 is based on IP technology, while cluster 103 is a wireless network based for example on IEEE 802.11. The devices on cluster 102 can for example be HAVi devices, or UPnP devices for which the bridges manage HAVi proxy representations.

A principle of the GUID-proxy solution according to the present embodiment is to announce, on a local cluster, the GUIDs of devices that are located outside of the local cluster, so that local HAVi devices gain knowledge of their existence. Once the remote GUID of a remote device is known, this device is addressable by a HAVi software element because the Messaging System knows in its internal table to which device it has to send a HAVi message. When a HAVi message is sent to a remote device, it's destination address is that of the proxy GUID. The messages from the HAVi middleware and the HAVi applicative modules (DCMs, FCMs, applications) based on a proxied GUID are appropriately passed on by the bridges.

The software architecture of a HAVi-HAVi bridge is depicted in FIG. 2. It is composed of two portals according to the present embodiment, although more than two portals are possible. Each portal is connected to a HAVi cluster (for example an IEEE 1394-1995 bus) and is an addressable entity on its cluster. A complete HAVi stack runs on the bridge. Whether a HAVi module simulates two instances of itself or whether two separated modules run at the same time for the same functionality is implementation dependent. In FIG. 2, only one messaging system is represented, although functionally speaking there is one per portal. A Software Element—and the messaging system is a Software Element—is addressed with the GUID of the node it resides in, and each portal possesses its own GUID.

a) The SddManager

The Self Describing Device data (SDD) is a means for a HAVi device to provide information about itself to other devices (type of device, capability, version etc . . . ). In HAVi-1.1, the SDD is part of the configuration rom (which contains other information, such as the GUID) of the IEEE 1394 HAVi device and is read by the other devices using direct IEEE 1394 Read transactions.

This is fine for a single IEEE 1394 cluster, but when the HAVi network is multi-clustered, and built on different medium technologies, such Read transactions are insufficient. What is needed then is a means to read the SDD data of any HAVi device on the network. This can be achieved by using HAVi messages. According to the present embodiment, the software element can access the SDD data of a HAVi device using the Messaging System. In order to provide SDD data on request to any client on any cluster, an appropriate application specific interface (API) is defined in the HAVi stack.

The SddManager is a new system software element that has similarities with the Registry in the sense that it locally handles requests for SDD data and collects responses from distant SddManagers, with the difference that a Registry exists on all devices with intermediate functionality (IAV) and full functionality (FAV), whereas a SddManager is implemented on any bridge aware HAVi device according to the present embodiment. A bridge aware device is of the FAV or IAV type (Full A/V device or Intermediate A/V device). No SddManager is present on a HAVi 1.1 or lower version device. Thus, devices with an SddManager will cohabit on the same cluster with devices devoid of SddManager. This means that a client application or software element in a HAVi device will preferably call its local SddManager for all requests, and the local SddManager will take care of collecting all information (sending query to other SddManagers and/or doing local low-level operations). If no local SddManager is present on the device, then the client will have to obtain the information through other means. In this latter case, the client is running on a HAVi-1.1 device that has no bridge knowledge. It can then access only local IEEE 1394 cluster devices.

According to the present embodiment, a client executes the following process to retrieve SDD data:

```
      if(local SddManager exists)
(301,302,303)  call the local SddManager
      else  //(i.e. the device is not a bridge aware device)
(304)  use local API (e.g. CMM1394) to retrieve the SDD data
        of the local cluster device  // it can be only the local
cluster here
```

In other words, a client application is preferably adapted to function both on a device with an SddManager and on a device without an SddManager.

According to the present embodiment, an SddManager caches SDD data information he obtains from events notified by other SddManagers. This allows reducing traffic on the network and reducing response time from an SddManager to a client when a request is made. The caching is thus centralized in the SddManager and has not to be done redundantly by several clients of the same device.

At the level of the SddManager, the following process is carried out:

```
    if(query from a client concerns local data only (i.e. in the
same device))
      send response
    else
      if(remote SddManager exists for the target device to be
queried)
(301)  call the remote SddManager
      else
        if(target device is on the local cluster)
(303)  use local API (e.g. CMM1394) to retrieve the SDD
data
        else //i.e. the target device is not bridge aware and
not on the local cluster
(302)  call the SddManager of the bridge exit portal
```

In other words, if the query received from a client does not concern only locally available data, then the SddManager first checks whether the target device for which the SDD data is to be retrieved contains an SddManager and in that case calls the target's SddManager. Else (i.e. the target device does not have an SddManager), it checks whether the target device is on the local cluster and uses a local API such as the Communication Media Manager to retrieve the data (e.g. CMM1394 for IEEE1394). For remote non-bridge aware target devices, the request is forwarded to the SddManager of the exit portal of the local cluster.

FIG. 3 illustrates the message sequences for the different cases referenced in the two processes above. The reference numbers correspond the steps given in the two processes above.

Preferably, an SddManager stores a list of all other SddManagers on the network (local and remote), and for the devices with no SddManager, stores the nearest portal's GUID (provided by the Network Manager as described below) to send the query to.

The SddManager provides the following services:

| | Comm | | |
|---|---|---|---|
| Service | Type | Locality | Access |
| SddManager::GetSddData | M | global | All |
| SddDataChanged | E | global | SddManager (all) |

The SddManager has the following data structures in the present embodiment:

(a) DeviceProfile

Definition

| struct DeviceProfile { | |
|---|---|
| DeviceClass | deviceClass; |
| boolean | withDcmManager; |
| boolean | withStreamManager; |
| boolean | withResourceManager; |
| boolean | withDisplayCapability; |
| boolean | deviceActive; |
| boolean | bridge; |
| }; | |

Description

This structure stores the values found in the IEEE 1394 configuration ROM under the HAVi_Device_Profile category (HAVi-1.1 specification page 458). The deviceClass parameter gives the type of the device (FAV, IAV . . . ). The withXxxManager booleans are True if the module is present in the device. withDisplayCapability indicates for an IAV whether a DDI Controller is present or not, and for a FAV if a DDI controller and a level2 UI (user inteface) are present. The deviceActive boolean is True if the device is active. The bridge parameter specifies whether the device is a bridge or not.

(b)Vendor

Definition

```
struct Vendor {
    VendorId  vendorId;  //defined in HAVi-
1.1 p110
    DeviceManufacturer vendorText;  //defined in HAVi-
1.1 p149
};
```

Description

Information about the manufacturer. The max number of character is 50, encoded in UNICODE UTF-16 on 2 bytes so the max size is 100 bytes.

(c) Model

Definition

```
struct Model {
    ModelId  modelId;  //defined in HAVi-1.1 p200
    DeviceModel  modelText;  //defined in HAVi-1.1 p149
};
```

Description

This structure gives linformation about the model. The max number of character is 50, encoded in UNICODE UTF-16 on 2 bytes so the max size is 100 bytes.

(d) DcmProfile

Definition

struct DcmProfile {

| | |
|---|---|
| uint | transferredDcmCodeUnitSize; |
| uint | installedDcmCodeSpace; |
| uint | installedDcmWorkingSpace; |
| Version | MessageVersion; //defined in HAVi-1.1 p110 |
| }; | |

Description

This structure contains information about the DCU. The fields are as defined by the HAVi-1.1 specification in section 9.10.7 p460.

(e) SddData

Definition

struct SddData {

| | | |
|---|---|---|
| Version | version; | //defined in HAVi- |
| 1.1 p110 | | |
| DeviceProfile | deviceProfile; | |
| Vendor | vendor; | |
| Model | model; | |
| UserPreferredName | userPreferredName; | //defined in HAVi- |
| 1.1 p150 | | |
| DeviceIcon | deviceIcon; | //defined in HAVi- |
| 1.1 p158 | | |
| DcmProfile | dcmProfile; | |
| sequence<octet> | dcmReference; | |
| }; | | |

Description

This structure provides information about the HAVi device. It is basically the same information as in the IEEE 1394 configuration ROM SDD part of the HAVi-1.1 specification. For detailed information on the fields, see HAVi-1.1 specification section 9. Note that a bit is added in the device profile, the bridge bit, represented by the bridge boolean in the deviceProfile structure. This piece of data is used to indicate whether the HAVi device is a bridge or not. Note also that the dcmProfile and dcmReference are valid fields only for BAV devices.

The SddManager's application programmable interface(API) is as follows:

SddManager::GetSddData

Prototype

Status SddManager::GetSddData(in GUID guid, out SddData sddData)
   Parameters
guid—the GUID for which the client wants to retrieve the SDD data.
sddData—the SDD data of the specified GUID.
   Description

This method retrieves the SDD data for a given HAVi device specified by its GUID. If the GUID is that of the local device (the client's host), the local SddManager sends the response with the corresponding SDD Data. If the GUID is that of a remote device, the local SddManager is in charge of retrieving the remote SDD data. This is done according to the process already presented above.

Error Codes

SddManager::EUNKNOWN_GUID—the GUID is unknown.
SddManager::ENOT_READY—the SDD data are currently being updated. The client may retry later.
SddManager::ELAV—the specified GUID is a LAV device, so has no SDD data.

The SddManager uses the following event:

SddDataChanged

Prototype

void SddDataChanged(in GUID guid, in SddData sddData)
   Parameters
guid—the GUID of the device which has changed of SDD data.
sddData—the new SDD data.
   Description

This event is used to notify the devices on the network of a change in the SDD data of the device specified by the GUID. A device hosting an SddManager can provide this event for its local SDD data.

A bridge device can provide the event for the SDD data of a remote device with no SddManager, by detecting the SDD data change on the portal local to the device (e.g. through multicast messages for an IP cluster) with changed SDD and transmitting the information to the SddManaqers of its other portals.

In this case (when the bridge disseminates an event for a device without SDD Manager), all the portals of the cluster with the device without SddManager will transmit the event to their own co-portals, who in turn will forward the event remotely, the local cluster being updated according to a known SDD process (Bus Reset and configuration ROM reading for an IEEE 1394 network, sending of a multicast packet for an IP network). A device without SDDManager can be e.g. a HAVi 1.1 device such as a basic (BAV) nonIEEE 1394 device. For a legacy device (LAV), there is no problem since it has no SDD data.

IEEE 1394 configuration ROM enhancement is carried out as follows:

To be coherent with the definition of the SddManager structures, a new field is added to the configuration Rom of the IEEE 1394 HAVi devices, as follows. This HAVi_Device_Profile is a 24 bits immediate value (as specified by IEEE 1212) field of the IEEE 1394 configuration Rom that already comprises:
HAVi_Device_Class [bit 0 . . . 3]
HAVi_DCM_Manager [bit 4]
HAVi_Stream_Manager [bit 5]
HAVi_Resource_Manager [bit 6]
HAVi_Display_Capability [bit 7]
HAVi_Device_Status [bit 8]
Bits 9 . . . 23 are reserved

A new field is added to this entry in bit 9:

The HAVi_Bridge is a 1-bit immediate value specifying for IAV/FAV devices whether this device is a HAVi bridge or not. For a BAV this bit shall be 0.

| HAVi_Bridge value | Meaning |
|---|---|
| 0 | is not a bridge |
| 1 | is a bridge |

b) The Communication Media Manager

The modified Communication Media Manager (CMM)of a bridge portal will now be described:

The APIs of the CMM of a bridge (the CMM of each portal in fact, since there is are several CMMs per bridge) are, according to the embodiment, globally accessible for at least some of their APIs/methods, instead of being accessible only to software elements of the host device (i.e. local accessibility). This is valid for each type of CMM. We describe hereafter the CMM for IEEE 1394 based devices (CMM1394) and the CMM for IP-based devices (CMMIP) as they exist in the bridge device.

The CMM1394 API becomes:

| | | | Access by/For |
|---|---|---|---|
| | Comm | | events: Sent by |
| Service | Type | Locality | (destination) |
| Cmm1394::GetGuidList | M | local | All |
| Cmm1394::Write | M | local | Trusted |
| | | global in | |
| | | bridges | |
| Cmm1394::Read | M | local | Trusted |
| | | global in | |
| | | bridges | |
| Cmm1394::Lock | M | local | Trusted |
| | | global in | |
| | | bridges | |
| Cmm1394::EnrollIndication | M | local | Trusted |
| | | global in | |
| | | bridges | |
| Cmm1394::DropIndication | M | local | Trusted |
| | | global in | |
| | | bridges | |
| <Client>::Cmm1394Indication | MB | local | CMM1394 (trusted) |
| | | global in | |
| | | bridges | |
| NewDevices | E | local | CMM1394 (all) |
| GoneDevices | E | local | CMM1394 (all) |
| NetworkReset | E | local | CMM1394 (all) |
| GuidListReady | E | local | CMM1394 (all) |

The CMMIP API is as follows:

| | Comm | | |
|---|---|---|---|
| Service | Type | Locality | Access |
| CmmIp::GetGuidList | M | Local | all |
| CmmIp::GetIpAddress | M | local | trusted |
| | | global in bridges | |
| CmmIp::GetGuid | M | local | trusted |
| | | global in bridges | |
| CmmIp::Send | M | local | trusted |
| | | global in bridges | |
| CmmIp::EnrollIndication | M | local | trusted |
| | | global in bridges | |
| CmmIp::DropIndication | M | local | trusted |
| | | global in bridges | |
| <Client>::CmmIpIndication | MB | local | CMMIP |
| | | global in bridges | (trusted) |
| NewDevices | E | Local | CMMIP (all) |
| GoneDevices | E | Local | CMMIP (all) |
| ChangedDevices | E | Local | CMMIP (all) |
| GuidListReady | E | Local | CMMIP (all) |
| ProxyGuidCreated | E | Global | CMMIP |
| | | | (CMMIP) |

The enroll and drop APIs allow a remote HAVi Software Element to receive low-level messages from a device local to the network of the CMM's portal. The ‘send’ APIs (send for IP, read-write-lock for IEEE 1394) allow sending of messages to a specific device on a remote cluster. For example, these means can be used by a Device Control Module (DCM) installed remotely to communicate with its controlled device over one or more bridges.

A HAVi SE wishing to use a remote CMM (i.e. not in the same device as itself has to be aware of the link technology used by the remote CMM, i.e. it has to know the above API.

The process used by the HAVi SE is:
Discovery of the remote CMM technology, by querying the local Registry (which sends a query to remote Registries) with a Software Element Type attribute value of 0×000000001 (i.e. Communication Media Manager), and retrieval of the SEID of the remote CMM. According to the present embodiment, the software handle (swHandle) part of this SEID gives the type of the CMM (0×0001 for CMM1394, 0×000009 for CMMIP.
The SE can then use the CMMs if it knows how to handle the corresponding link technology. E.g. it has to be able to specify the contents of a message to be sent to the remote device, based on this technology.

FIG. 4 shows an example, in which the software element of the device having its GUID equal to 1 instructs the remote CMMIP of the bridge to send an IP message to the remote IP device having GUID equal to 3.

To summarize, at least certain functions of CMMs of bridge portals are made accessible to clients other than clients local of the CMM's own device, in order, in particular, to allow these clients to use the CMM's APIs for communicating directly on different network technologies, e.g. for sending low-level messages.

c) Device Discovery/Network Manager

e According to the present embodiment, a Network Manager software element is created to provide information about all the devices connected to the entire HAVi network. A CMM provides the list of the GUIDs connected to its local cluster. The Network Manager is able to give the list of GUIDs of the entire multi-clustered network, including the local cluster. There is a Network Manager in each portal. Network Managers are preferrably also be present in bridge aware devices.

The following services are provided by the Network Manager:

TABLE 7

| | Comm | | |
|---|---|---|---|
| | Type | | Access/For |
| | (Message or | | events: Sender |
| Service | Event) | Locality | (Receiver) |
| NetworkManager::GetNetDeviceList | M | local | All |
| NetworkManager::GetNetDeviceInfo | M | global | All |
| NetworkManager::NetworkUpdated | E | local | Network Manager (all) |
| NetworkManager::GetRemoteDeviceList | M | global | Network Manager |
| NetworkManager::RemoteNetworkChanged | E | global | Network Manager in |
| | | | bridges (Network |
| | | | Managers in bridges) |
| NetworkManager::RemoteNetworkUpdated | E | global | Network Manager (sent |
| | | | to all Network |
| | | | Managers) |

The Network Manager data structures are as follows:

(a) ClusterType

Definition

enum ClusterType {IEEE1394, IP};

Description

The ClusterType provides information on the technology used on a specific cluster. According to the present embodiment, two clusters technologies are defined, 1394 (HAVi-1.1) and IP, but others could easily be added.

(b) NetDeviceInfo

Definition

| struct NetDeviceInfo { | |
|---|---|
| GUID | deviceGuid; |
| uint | hops; |
| GUID | nearestPortalGuid; |
| ClusterType | clusterType; |
| }; | |

Description

The NetDeviceInfo structure provides information about a device whatever its location in the network, i.e. it provides the GUID itself, the number of hops to reach it (used by Network Managers to solve loop issues as explained later), the GUID of the nearest portal to reach this device and the type of the cluster it is connected to. The last two items allow a client to reach the CMMXXX on this nearest portal to access the low-level features of the remote cluster and send low-level messages to the remote device.

(c) RemoteNetworkState

Definition

enum RemoteNetworkState {STABLE, CHANGING, FINAL};

Description

The RemoteNetworkState provides information on the state of the remote network behind a portal (i.e. the clusters behind the portal comprising the network manager). STABLE means that the remote cluster device lists of the portals are stable and the other Network Managers can rely on them. CHANGING means that the remote lists are still subject to modifications. FINAL means that the remote lists of the portal should be stable but that a confirmation is needed by the other portals of the cluster (see the behaviour discovery process for more details).

The Network Manager API is as follows:

(a) NetworkManager::GetNetDeviceList

Prototype

```
Status NetworkManager::GetNetDeviceList(
    out uint updateId,
    out sequence<NetDeviceInfo> activeNetDeviceList,
    out sequence<NetDeviceInfo> nonactiveNetDeviceList)
```

Parameters
updateId—the update number of the network. This number is incremented by one each time the lists are changed, it can be used by clients to check if the network remains the same or not.
activeNetDeviceList—the list of all active devices on the network. The first item shall be the local device.
nonactiveNetDeviceList—the list of all non-active devices on the network.
   Description

This API returns the list of all devices on the entire network, split into an active device list and an inactive device list. The information about each device is contained in NetDeviceInfo structures. This gives the GUID of the device, the GUID of the nearest portal to reach it, and the type of cluster it is attached to. E.g. in FIG. 4, the SE retrieves the GUID 3, sees that its cluster is IP-based, and that the nearest portal to reach it is the GUID 6, so it can now send a CmmIp:: Send HAVi message to the CMMIP of the device having its GUID equal to 6.

Error Codes

NetworkManager::ENOT_READY—the lists are not available yet, the system may be updating them. This is a transient error, the client software element may retry or use the NetworkUpdated event.
   (b) NetworkManager::GetRemoteDeviceList

Prototype

```
Status NetworkManager::GetRemoteDeviceList(
    out uint updateId,
    out sequence<NetDeviceInfo> activeRemoteDeviceList,
    out sequence<NetDeviceInfo> nonactiveRemoteDeviceList)
```

Parameters
updateId—the update number of the remote network. This number is incremented by one each time the list are changed, it can be used by clients to check if the remote network remains the same or not.
activeNetDeviceList—the list of all active devices on the network behind this bridge.
nonactiveNetDeviceList—the list of all non-active devices on the network behind this bridge.
   Description

This API returns the list of all reachable devices on the network behind the bridge comprising the Network Manager, split into in a list of active devices and a list of inactive devices (an active device being a device ready to receive messages, HAVi for IAV and FAV, private for BAV, as specified by the SDD data of a device). The information about each device is contained in the NetDeviceInfo structure. This gives the GUID of the device, the GUID of the exit portal to reach it, the number of hops, the nearest portal and type of cluster it is attached to. In the present embodiment, the access to this API is restricted to Network Managers. It is used by the Network Manager of a device (bridge or not) to query the remote device list of a bridge device, and consequently to build its internal table and solve loop issues. According to a variant, the API is made available to other software elements as well.

Error Codes

NetworkManager::ENOT_READY—the lists are not available yet, the system may be updating them. This is a transient error, the client software element may retry or use the RemoteNetworkChanged event (for Network Managers of bridge devices only) and RemoteNetworkUpdated event (for all Network Managers).
   (c) NetworkManager::GetNetDeviceInfo

Prototype

Status NetworkManager::GetNetDeviceInfo(

in GUID guid,
out NetDeviceInfo deviceInfo)

Parameters
guid—the GUID the client wants some info on.
deviceInfo—the information on this device, i.e. the corresponding NetDeviceInfo structure.
   Description

This API provides complete information on a given network device. The Network Manager returns the NetDeviceInfo structure.

Error Codes

NetworkManager::EUNKNOWN_GUID—the GUID is unknown.

Network Manager events are as follows, according to the embodiment:

(a) NetworkUpdated

Prototype

void NetworkUpdated(

in uint updateId,
in sequence<NetDeviceInfo> activeNetDeviceList,
in sequence<NetDeviceInfo> nonactiveNetDeviceList,
in sequence<GUID> changedDevices,
in sequence<GUID> goneDevices,
in sequence<GUID> newDevices)

Parameters
updateId—the update number of the network. This number is incremented by one each time the list are changed, it can be used by clients to check if the network remains the same or not.
activeNetDeviceList—the list of active devices on the entire HAVi network. The first item shall be the local device.
nonactiveNetDeviceList—the list of non-active devices on the entire HAVi network.
changedDevices—the list of GUIDs which changed of hops and nearest portal.
goneDevices—the list of GUIDs which left the network.
newDevices—the list of GUIDs which joined the network.
   Description

NetworkUpdated is a local event, sent to software elements of the device hosting the Network Manager. This event is generated when there is a change somewhere on the HAVi network (whatever cluster), i.e. after the Network Manager receives one or more RemoteNetworkUpdated events from the bridges connected to its local cluster (remote change) or after a change on the local cluster. During the reconfiguration time, the Network Manager may return NetworkManager::ENOT_READY for the NetworkManager::GetNetDeviceList API until NetworkUpdated. The definition of activeNetDeviceList and nonactiveNetDeviceList contents are the same as those defined in NetworkManager::GetNetDeviceList API. The changedDevices, goneDevices and newDevices fields provide only the GUID because the gone devices were known in the old device list and the new and changed devices are provided with complete information in the new device lists.

According to a variant embodiment, this event is made accessible to Software Elements residing in other devices on the same cluster, if those devices have no Network Managers.

(b) RemoteNetworkUpdated

Prototype

void RemoteNetworkUpdated(

in uint updateId,
in sequence<NetDeviceInfo> activeRemoteDeviceList,
in sequence<NetDeviceInfo> nonactiveRemoteDeviceList,
in sequence<GUID> changedDevices,
in sequence<GUID> goneDevices,
in sequence<GUID> newDevices)

Parameters
updateId—the update number of the remote network. This number is incremented by one each time the list are changed, it can be used by clients to check if the remote network remains the same or not.
activeNetDeviceList—the list of active devices on the entire HAVi network.
nonactiveNetDeviceList—the list of non-active devices on the entire HAVi network.
changedDevices—the list of GUIDs which changed of hops and nearest portal.
goneDevices—the list of GUIDs which left the network.
newDevices—the list of GUIDs which joined the network.
   Description

RemoteNetworkUpdated is a global event for Network Managers only. This event is generated when the Network Manager has detected a change in the part of the network he is proxying for its local cluster, and when the network is considered as stable (contrary to the next event, which is sent to bridge Network Managers only and which is used when the state of lists is not yet stable). This can happen because of a change on the Network Manager co-portal cluster or because of a change forwarded by a bridge connected to its co-portal. During the reconfiguration time, the Network Manager may return NetworkManager::ENOT_READY for NetworkManager::GetRemoteDeviceList API until RemoteNetworkUpdated. The definition of activeRemoteDeviceList and nonactiveRemoteDeviceList contents are same as defined in NetworkManager::GetRemoteDeviceList API. The changedDevices, goneDevices and newDevices fields provide only the GUID because the gone devices were known in the old device list and the new and changed devices are provided with complete information in the new device lists.

(c) RemoteNetworkChanged

Prototype

void RemoteNetworkChanged(

in RemoteNetworkState state,
in uint updateId,
in sequence<NetDeviceInfo> activeRemoteDeviceList,
in sequence<NetDeviceInfo> nonactiveRemoteDeviceList,
in sequence<GUID> changedDevices,
in seguence<GUID> goneDevices,
in sequence<GUID> newDevices)

Parameters
state—the state of the remote network, this is useful to solve the loop issues with remote lists iterations.
updateId—the update number of the remote network. This number is incremented by one each time the list are changed, it can be used by clients to check if the remote network remains the same or not.
activeNetDeviceList—the list of active devices on the entire HAVi network.
nonactiveNetDeviceList—the list of non-active devices on the entire HAVi network.
changedDevices—the list of GUIDs which changed of hops and nearest portal.
goneDevices—the list of GUIDs which left the network.
newDevices—the list of GUIDs which joined the network.
   Description

RemoteNetworkChanged is a global event destined to Network Managers of bridge devices only. It is the same as the RemoteNetworkUpdated event but this one is used by Network Managers in bridge devices during their reconfiguration steps. During these steps, several events may be generated before a stable network state is reached (especially if loops are present). This avoids sending to bridge aware devices messages that won't be used because the network is not stabilized yet. Meaning of the fields is the same as for the RemoteNetworkUpdated event.

Based on the above, the discovery process between bridges according to the present embodiment is as follows:

The aim is to discover all the devices connected to the HAVi network. Once this is done the ‘remote’ device lists in each portal give the information about which devices are reachable through themselves. While the IEEE 1394.1 topology opens loops by muting a bridge, the behavior regarding loops is different in this embodiment. According to the present embodiment, a bridge may be passing for certain paths but not for others, so when a loop exists, the bridges will not be totally muted but they will offer GUIDs in their remote list if they are on a particular path to the devices identified by these GUIDS. Whether a bridge is passing or not is decided based on certain criteria as explained below. In the present example, the number of hops reflects the number of portals to cross in order to reach the destination and not the number of bridges. This choice is made since a portal may be reached via its co-portal rather than via its cluster (i.e. there is no necessity for messages to a portal of crossing the entire bridge, while the bridge would have to be crossed entirely for a non-portal device on the cluster).

The basic discovery process is as follows:

Each local cluster carries out its own local discovery process. The discovery process for an IEEE 1394 cluster, known in itself, is based on the IEEE 1394 Bus Reset inducing topology information dissemination using ‘selfID’ packets.

Once this stage is over, the CMM1 394s read the configuration rom of all nodes to to obtain their GUIDs. The SDD data is read (if present) to obtain HAVi-defined information about the connected devices.

The discovery process for an IP cluster, known in itself, is based on multicast announcement packets.

The CMMIPs according to the embodiment build their GUID list based on these announcements, which occur e.g. when a new device is connected to the cluster. The SDD data are also contained is those packets.

At this point, the local GUID list and SDD data are known for both cluster types, and therefore the Network Managers of the clusters know the bridge devices present on their local cluster.

To build the complete network device list, the Network Managers start to query each other.

The process according to the present embodiment is:
(1) Network Managers look for bridges on their cluster.
(2) Network Managers of bridge devices call the NetworkManager::GetRemoteDeviceList API of the portals of the other bridge devices connected to their local cluster. The co-portals of these queried portals should already be building the lists of devices on their side of the network.
(3) Network Managers of bridge devices obtain from their co-portal (by HAVi messages or, according to a preferred embodiment, via bridge internal information sharing, etc.) the list that will become their own remote device list. The co-portal is able to provide this list when it has called the NetworkManager::GetRemoteDeviceList API of the other bridge devices connected to its own cluster.
(4) Network Managers of bridge aware (BA) devices call the NetworkManager::GetRemoteDeviceList API of the bridge devices connected to their local cluster. This builds their entire network GUID list.

HAVi SEs call the NetworkManager::GetNetDeviceList API of their local Network Manager.

If a step is done before the requested information is available, the ENOT_READY error may be returned and the client will have to wait. According to the present embodiment, the steps 1 and 2 are in fact done in parallel, so a mechanism is proposed to avoid dead lock issues. The device list building process progresses from the leave clusters to the root cluster of the topology (at least for a network without loops).

Discovery rules are as follows:

The following rules are applied for the discovery process. They are categorized according to remote Network states, i.e. ‘Changing’, ‘Final’ or ‘Stable’. Moreover, some Generic rules exist, applicable whatever the state. Rules are consequently classified in “G”, “C”, “F” and “S” categories.

TABLE 8

| | |
|---|---|
| G1 | After first local discovery, remote list is empty (response |
| | ENOT_READY is sent if a corresponding request is received), ask |
| | co-portal for a remote list (even incomplete, but at least the co-portal's |
| | local list), then request remote lists from other portals of the clusters, |
| | if any. |
| G2 | After reconfiguration of local cluster and local discovery with |
| | new/gone devices, check for new bridges on the cluster. |
| G2.1 | No new bridges => keep the previous state and update the co-portal if |
| | STABLE state. |
| G2.2 | New bridges => check for duplicate GUIDs between the new local list |
| | and the old remote list (may e.g. happen when a new bridge allows a |
| | shorter route than the old topology). |
| G2.2.1 | Duplicate GUIDs => go to CHANGING state and ask for remote list of |
| | new portals. |
| G2.2.2 | No duplicate GUIDs => go to FINAL state and ask for remote list of |
| | new portals. |
| G3 | Duplication management: the portal with the smallest hops field wins |
| | (i.e. is selected as being on the path to the device), and in case of |
| | equal number of hops, the portal with the highest reverse GUID wins |
| | (other criteria to resolve ties may of course be used). |
| C1 | When receiving an ENOT_READY error response from a portal of the |
| | cluster, update the co-portal with an incomplete list (it will be at least |
| | the local cluster's list) if something has changed since the last update |
| | and if not S3. Wait a certain amount of time for an event from the |
| | portal and ask again for remote list if no event has been received. |
| C2 | When receiving a CHANGING event or response from another portal |
| | of the cluster, check for duplicate GUIDs. |
| C2.1 | If duplicate GUIDs => go to FINAL state, remove duplicate GUIDs |
| | (hops rule G3), and send FINAL event on the cluster. |
| C2.2 | If no duplicate GUIDs => update the co-portal in CHANGING state if |
| | not S3. |
| C3 | Update from co-portal in CHANGING state => check for duplicate |
| | GUIDs. |
| C3.1 | Duplicate GUIDS => go to FINAL state, remove duplicate GUIDs |
| | (hops rule G3), and send FINAL event on the cluster. |
| C3.2 | No duplicate GUIDs => send CHANGING event on the cluster if not |
| | S4. |
| F1 | Receiving a FINAL event from another portal of the cluster => check |
| | the duplicate GUIDs. |
| F1.1 | Duplicate GUIDs: management of duplication (hops rule G3) |
| F1.1.1 | All in favor of him (other portal of F1) => send STABLE event to |
| | confirm. |
| F1.1.2 | At least one in favor of me (present portal carrying out the process) => send FINAL |
| | event with updated list. |
| F1.2 | No duplicate GUIDs => send STABLE event to confirm. |
| S1 | Receiving STABLE lists from all other portals of the cluster => update |
| | the co-portal with a STABLE list if this list is different from the |
| | previous STABLE one which was sent. |
| S2 | STABLE update from co-portal => check for duplicate GUIDs. |
| S2.1 | Duplicate GUIDs => already known and managed ? |
| S2.1.1 | Yes => send STABLE event if last event was not STABLE or if |
| | new/gone GUIDs from the last sent STABLE event. |
| S2.1.2 | No => go to FINAL state, remove duplicate GUIDs (hops rule G3), |
| | and send FINAL event on the cluster. |
| S2.2 | No duplicate GUIDs => send a STABLE event on the cluster. |
| S3 | When the remote list is in STABLE state, no update of the co-portal is |
| | done on reception from other portal of the cluster of not STABLE lists. |
| S4 | If all the other portals of the cluster are STABLE, no event is sent on |
| | the cluster for update from co-portal of not STABLE list |

The above process includes steps to ensure through—if necessary—an iterative processing that redundant path conflicts are properly resolved. For this purpose, the three possible states—Changing, Stable and Final are defined. The information regarding these states is propagated using the RemoteNetworkState data structure in the RemoteNetworkChanged event.

According to a variant embodiment, a time out process is implemented in this discovery process in order to avoid having slower bridges flooded by a large amount of events from the others bridges before being able to reply.

(d) Message Sending

According to the HAVi specification, a HAVi message is sent from a Software Element to another Software Element. A Software Element is identified by a SEID (Software Element Identifier). This SEID is composed of the GUID of the device in which the Software Element resides and of a swHandle unique within the device. The header of a HAVi message contains the destination SEID and the source SEID.

In the present embodiment, the bridge device does not modify a HAVi message (what we call here HAVi message does not contain the TAM header). The destination SEID, source SEID, protocol type, message type, message number, message length and message body fields are kept identical. The Messaging System will, however, route the message to the destination. To do so, when a Messaging System in a bridge receives a HAVi message on a cluster, it looks at the destination SEID and more precisely the GUID contained in this SEID. If this GUID is its own GUID, then this message is for an internal SE and it delivers it. If this GUID is present in its remote GUID list, then it forwards the message to its co-portal (or the appropriate co-portal should there be more than one co-portal). The co-portal will then send this message to the corresponding destination device (regarding its internal table). This device can be the final destination device or the next bridge on the path.

Regarding the Messaging System's general behaviour, nothing is changed:

The message number still follows the rules in section 3.2.1.2.3 of the HAVi-1.1 specification, p29. This is true for the initial sender and final receiver of the message. The Messaging Systems in the bridges on the path don't care about what is inside the HAVi message, they just forward it.

A ‘simple’ message (i.e. no acknowledgment requested) is just sent and no acknowledge is required.

A ‘reliable’ message is sent, and the caller is blocked until the positive or negative acknowledgment (Ack or Nack) is received. This is true for the initial sender, the Messaging Systems in the bridges on the path just forward the messages (initial message, Ack or Nack messages).

Returning to the topology of FIG. 4, when a SE in the device with GUID 1 wants to send a HAVi reliable message to another SE in the device with GUID 3, the Messaging System of the device with GUID 1 sends the message to the bridge portal (device with GUID 5). The Messaging System of the bridge looks at the destination SEID and more precisely the GUID contained in this SEID, and deduces that this message is for a device of its remote list. It then forwards the HAVi message to its co-portal, which in turn sends it to the device with GUID 3 (see FIG. 5). The Acknowledge response is then sent from the device with GUID 3 through the bridge to the device with GUID 1.

Error handling is performed as follows:

Nothing more than already defined in the HAVi-1.1 specification is added to the error handling of HAVi messages. In fact the Messaging Systems in the bridges on the path are just forwarding the message.

(e) Event Manager

When a SE is sending an event (with the EventManager::PostEvent API), the Event Manager is posting it on its local cluster only (with the EventManager::ForwardEvent API). The Event Manager of a bridge which receives an event from another Event Manager will forward it to its co-portal. The co-portal will then send this event to its cluster (with the EventManager::ForwardEvent API), etc.

The rule for a portal's Event Manager to forward or not an event to its co-portal is whether or not the GUID of the original poster exists in the remote list of its co-portal. The GUID of the original poster is given as parameter in the ForwardEvent message. Here is a reminder of the ForwardEvent API:

Status EventManager::ForwardEvent(

in SEID posterSeid,
in EventId eventId,
in sequence<octet> eventInfo)

The posterSeid parameter is the SEID of the original SE which posted the event to its local Event Manager. The GUID contained in this SEID gives the GUID of the device the SE resides in. This GUID is used by a portal to decide if it forwards the event or not.

While a bridge forwards to remote clusters events from non BA-devices (those devices are controllable from remote devices), the Event Manager of a portal does not forward to the Event Managers of non BA-devices of its cluster the event messages received from its co-portal (i.e. remote events).

The error handling for events remains the same as in HAVi-1.1 (see the Event Manager protocol section 5.4.5, p144) for the basis. The small update is that each portal acts as a proxy for what is behind it. So the Event Manager will receive responses from Event Managers of its local cluster (the ones it sent messages to), and a portal will respond when it has received all the responses from its co-portal cluster, merging and reflecting those responses.

FIG. 6 shows the basic process for event posting on a multi-clustered network. The event posted from a SE in the device having GUID 3 is forwarded by the Event Manager of the device having GUID 3 to all Event Managers of its cluster. The portals then forward this event to the remote cluster as soon as the GUID of the poster is in the remote list of their co-portal (that is why the portal 6 does not forward it to the portal 5). The portals then forward this event to the Event Managers on their clusters except for the non BA-devices (that is why the device 2 does not receive this event).

According to a variant embodiment, the “global” parameter of the PostEvent API is modified as follows. Currently it is defined as a boolean indicating whether the event is local to the device or global to the HAVi network. This boolean is replaced by an ‘enum’ structure as follows:
enum EventScope {LOCAL, CLUSTER, NETWORK};

In the preferred embodiment, the PostEvent API is left unchanged.

(f) Registry

In HAVi, a Registry query request (Registry::GetElement or Registry::MultipleGetElement) is sent by an SE to a Registry. The basic process is for an SE to query its local Registry, and the latter will then forward the query to all other Registries on the HAVi network. As soon as a Registry receives a query from a remote node, it just answers to the query after having searched its own database.

This concept is kept here with the bridges. A Registry receiving a query from a remote node will answer searching its own database, except for the Registries in the bridge devices. The basic process remains for an SE to query its local Registry, which will forward the request to all the Registries on the network. This is detailed hereafter.

The Registry of a portal naturally forwards the requests coming from Registries of its cluster to the Registry of its co-portal. But it will do it only if the GUID of the initial sender of the request is present in the remote list of its co-portal (i.e. its co-portal is on the reverse path to the initial sender). As before, this avoids sending the message over different paths to the same destination. If this initial GUID is not in the remote list of its co-portal, then the request will not be forwarded. This can happen with topology loops. In this case, its co-portal will receive the request via the bridge on its cluster which proxies the initial GUID (so by another route). Moreover, the Registry of a bridge does not forward the requests from Registries of non BA-devices. Those devices have no knowledge of the remote GUIDs, so would not be able to send messages to a remote SEID (the basic query to a Registry returns a SEID, which comprises the GUID).

When solicited, the Registry of the co-portal can then forward the request to the other Registries on its cluster, including other bridges. The Registry request is consequently sent on the entire network.

The Registry of a BA-device sends its query only to its cluster, so the Registry communication between clusters is controlled by the Registries themselves (‘Cluster separation’). In FIG. 7, a three-bridges loop network is shown with the Network Manager lists (local and remote).

According to a variant embodiment, the basic process is as follows: the initial Registry (device GUID 1) sends the query to all Registries on the entire network. The number of HAVi messages sent on the first cluster is then nine (since there are nine registries on the network), one for each Registry. On the other clusters this number decreases, since not all messages are forwarded by all bridges.

According to the preferred embodiment, the initial Registry (GUID 1) sends the query to all Registries of its own cluster only. The number of HAVi messages on this first cluster is now three. Then, the Registries of the bridge repeat this operation with the clusters of their co-portals (but only if the initial sender GUID 1 is present in the remote list of their co-portal: that is why the portal having GUID 7 does not forward it to the portal having GUID 8).

This small example shows the improvement for the query (three messages instead of nine), but the same phenomenon appears with the responses. With the preferred embodiment, Registries in portals create one single response by merging all the responses of their co-portal cluster Registries. Furthermore, in this example every device is reachable through one bridge, but when several bridges are chained the number of redundant HAVi messages becomes huge in the clusters near the initial sender.

Registry messages processing is carried out as follows:

With the cluster separation, the initial Registry queries all the Registries on its cluster. This reduces the overall traffic for requests. Then the Registries in the bridges forward the request. In order to be able for a portal to know if it has to forward the request to its co-portal (based on the remote list of the co-portal), the source SEID of the HAVi message has to be the one of the initial sender (if this source SEID is changed, then a query in a loop network will have no end, because of the route management chosen for the Network Manager behaviour). But then all the Registries in the network will respond to the initial requester and this one will receive more responses than it has sent queries, which might not be understood. This is why according to the present embodiment, the initial requester receives responses from Registries of its local cluster only.

The following variants can be used to solve this issue (with the GetElement example):
1. The Registry of a BA-device knows that it sends queries only to its cluster but that it will receive responses from all Registries of the entire network. The reduction in the number of messages is done for the requests only, not the responses. It can work because requests from non BA-devices are not forwarded.

2. The Register::GetElement API is modified. A new parameter is added to include the information about the SEID of the initial requester. The API becomes:

Status Registry::GetElement(

in SEID initialRequester,
in SimpleQuery query,
out sequence<SEID> seidList)

A portal of a bridge receiving this message knows if it has to forward or not the query to its co-portal based on the GUID contained in the SEID of this initial requester parameter. The traffic improvement is done for responses. The bridge, when forwarding the request to its remote cluster, has to send HAVi 1.1 messages to HAVi 1.1 devices and this new message to BA-devices (based on the version field of the SDD of each device). Those requests are new ones, with the source SEID of the bridge (and not of the initial requester anymore). The portal will collect all the responses sent to it (because it is the source SEID of the request) and merge them into one SEID list that it will send to it's the inital requester (the device it originally received the request from).

3. In variant 2 above, non-bridge Registries do not use the identification of the initial requester. This information is only useful for Registries of bridge devices, in order to decide whether to forward the request or not to the remote cluster. Another variant consists in extending the Register's API with a new method call dedicated to bridge devices. A bridge aware registry would use this call for portal registries.

Status Registry::ForwardGetElement(

in SEID initialRequester,
in SimpleQuery query,
out sequence<SEID> seidList)

The called bridge device then has knowledge of the identity of the initial requester. Non-bridge devices receive the normal GetElement call. Both calls contain the source SEID of the bridge, not the initial requester's SEID. When the bridge has received all the responses from the Registries, it merges them into one SEID list and responds to the ForwardGetElement call it initially received.
4. A fourth variant consists in avoiding modifying the Register API. The GetElement request is forwarded as-is by a bridge, i.e. without modifying the source SEID in the HAVi message. When a bridge device receives a response from a Registry on its cluster (another bridge or a non bridge device), it does not forward it. It analyzes it, and extracts the SEID list in order to build the merged SEID list it will send back to the requester it had received the query from. When it has received all the responses, it can send its own response with the merged SEID list.

The next table tries to summarize the pros and cons of the four proposed variants.

TABLE 9

| | Traffic improvement | Change in the | Bridge |
|---|---|---|---|
| Variant | for responses | Register API | intelligence |
| 1 | no | No | low |
| 2 | yes | Yes | medium |
| 3 | yes | Yes | medium |
| 4 | yes | No | high |

The preferred variants are the number three and four, because the GetElement API need not be modified. Variant three has the advantage to enable synchronization between the bridges.

FIG. 8 gives an example of the interactions for a GetElement call using the third variant.

The initial sender sends a GetElement request to its local Registry. The local Registry then forwards this GetElement request to the other Registries on its local cluster. When the Registry of a bridge receives this request, it transmits it to its co-portal Registry (provided the GUID contained in the source SEID be in the remote list of this co-portal). This is then considered as a new request. This new request is sent to the Registries on the cluster of the co-portal. The GetElement is sent to non bridge devices, and the ForwardGetElement is sent to the bridge devices. The process is reiterated if other bridges are present on this cluster.

On each remote cluster, different requests are sent by the Registry of the bridge device, i.e. the bridge does not simply place the initial request on the remote cluster. The bridge device keeps track of these requests to give back the responses of the Registries of its cluster to its co-portal. When the Registry of a bridge device has received all the responses from the Registries of its cluster, it merges them into one single response (one SEID list) and provides it to its co-portal. The co-portal can then send this SEID list augmented with its own SEID list to the requester Registry. This response will be a ForwardGetElement response if the requester Registry was within another bridge or a GetElement response for the bridge connected to the initial requester.

In the specific example of FIG. 8, the SEID list is merged by the bridge devices:
Portal with GUID 6 gives back to its co-portal with GUID 5 the list from the device with GUID 7 (E) and its own list (D). Portal with GUID 5 takes this list and add its own list (C). Result is (C,D,E).
Portal with GUID 10 gives back to its co-portal with GUID 9 the list from the device with GUID 8 (empty), from the device with GUID 3 (empty), from the device with GUID 4 (F) and its own list (empty). Result is (F).
The Registry of device with GUID 1 receives responses from device with GUID 2 (B), from device with GUID 5 (C,D,E) and from device with GUID 9 (F). It adds its own list (A) and gives back the answer to the SE. The final result is (A,B,C,D,E,F).

What has been mentioned for the GetElement method is also applicable to the MultipleGetElement method. What follows is the new API specifically devoted to bridge Registries:

Status Registry::ForwardMultipleGetElement(

in SEID initialRequester,
in ComplexQuery query,
out sequence<SEID> seidList)

(g) Streams

The known HAVi Stream Manager is a system software element that permits establishing of stream connections. A stream connection associates a source functional component element and a sink functional component (consequently the associated source, and a sink device) and guarantees the availability of the required resources. These resources may be channel, bandwidth, etc. FIG. 9 shows the stream connection model specified by HAVi. Two functional components are inter-connected. An internal connection between a functional control module and a device control module (FCM/DCM) has been made in each associated device. A device connection has been made between associated devices (the two Full A/V devices of FIG. 9). The logical connection is at the HAVi level (i.e. between software elements) while the physical connection involves the real equipments (those represented by DCMs/FCMs at the logical level).

After a stream connection has been established, a stream may be sent between the source and the sink. In HAVi, each application that wants to create a stream connection shall use its local Stream Manager (i.e. the Stream Manager located in the same device).

According to the HAVi specification a functional component is represented somewhere in the network by a FCM (Functional Component Module) as the device is represented somewhere in the network by a DCM (Device Control Module). When a client application requests a stream connection from its local Stream Manager, it indicates the identity of the source and the sink functional components. The information provided to the Stream Manager is grouped in the FcmPlug structure:

The TargetId: the GUID of the device where the functional component (not the FCM) is located and an index to the component within the device.

The plug direction: in or out.

The plug number if the functional component manages several plugs.

The Stream Manager uses the services of the DCM to realize the internal connection (i.e. the connection within the device). To operate the DCM module, the Stream Manager uses HAVi messages. Therefore, the way to establish an internal connection does not depend on the medium's technology (e.g. IEC61883/IEEE1394).

The Stream Manager uses the services of its link layer (e.g. IEC1883 CMP protocol) to set up the device stream connection.

According to the present embodiment, the process for multi-clustered streams is as follows:

On a single cluster HAVi network, to establish a stream a client uses its local Stream Manager. This local Stream Manager is entirely responsible for this stream. On a multi-clustered network, the Stream Manager local to the client may not be on the same cluster as the source and/or sink devices. Furthermore, it may not be aware of the medium technology used for the source and/or sink device. Thus the basic principle is to make the Stream Managers on the path collaborate.

For simple mono-cluster streams, the client is able to specify transport type, transmission format, channel and plugs to be used by the Stream Manager. For multi-clustered streams, it is not realistic to think that the client can choose all those parameters for every cluster the stream will cross (the aim is to be able to have a medium technology that the client is not aware about at all). So the client has just to specify the bandwidth policy (static or dynamic) and the stream type (which is unique on the stream). Then the Stream Managers are responsible for all the transport issues.

Broadcast streams in HAVi are set up with the Stream Manager SprayOut and TapIn APIs.

According to the present embodiment, when a Stream Manager receives a local call on those APIs and the targeted device is remote (i.e. not on the local cluster), it will forward this call to the Stream Manager of the nearest portal connected to the targeted functional component (the device). This Stream Manager will then perform the broadcast connection, but this connection will be only local to the remote cluster. So broadcast streams do not cross bridges, but can be controlled remotely.

The proposed API for Point-to-point streams will now be described.

In order to keep the backward compatibility with HAVi-1.1 devices, there is a need to define a new Stream Manager method for those streams crossing bridges or on remote clusters. It is presented hereafter.

Compared to the known Stream Manager API, the new methods are underlined.

TABLE 10

| | | | Access/For |
|---|---|---|---|
| | Comm | | events: Sender |
| Service | Type | Locality | (Receiver) |
| StreamManager::FlowTo | M | local | all |
| StreamManager::MultiClusterFlowTo | M | global | all |
| StreamManager::OnThePath | M | global | Stream |
| | | | Managers in |
| | | | bridges |
| StreamManager::SprayOut | M | local | all |
| StreamManager::TapIn | M | local | all |
| StreamManager::Drop | M | global | all |
| StreamManager::GetLocalConnectionMap | M | global | all |
| StreamManager::GetGlobalConnectionMap | M | global | all |
| StreamManager::ForwardGetGlobalConnectionMap | M | global | Stream |
| | | | Managers in |
| | | | bridges |
| StreamManager::GetConnection | M | global | all |
| StreamManager::GetStream | M | global | all |
| ConnectionAdded | E | global | Stream |
| | | | Manager (all) |
| ConnectionDropped | E | global | Stream |
| | | | Manager (all) |
| ConnectionChanged | E | global | Stream |
| | | | Manager (all) |

(a) StreamManager::MultiClusterFlowTo

Prototype

Status StreamManager::MultiClusterFlowTo(

in boolean dynamicBw,
in FcmPlug source,
in FcmPlug sink,
in boolean anyStreamType,
in StreamType streamType,
out ConnectionId connId)

Parameters
dynamicBw—indicates whether dynamic (dynamicBw is True) or static (dynamicBw is False) bandwidth allocation should be set.
source—a FcmPlug structure identifying a source plug.
sink—a FcmPlug structure identifying a sink plug.
anyStreamType—indicates whether the stream type has to be the one specified by the client or chosen by the Stream Manager.
streamType—the stream type if specified by the client.
connId—a ConnectionId value returned by FlowTo.
   Description

This API allows a client to request the creation of a stream on the multi-cluster HAVi network. On such a network, the source device and the sink device are not necessarily on the same medium type. The only parameter which has to be the same for the source and sink is the stream type. Stream type can be converted but this would be done in a converter module (e.g. a Converter FCM with an input for one stream type and an output for another different stream type). Transport type conversion is carried out by bridges. According to the present embodiment, a bridge connecting two different medium technologies is able to convert the transportation type of streams and messages from one type to the other.

Consequently, according to the present embodiment, the client does not take care of the transport type(s), the transmission format(s) and the channel(s) used for this multi-clustered connection. This will be handled by the Stream Managers of the bridges on the path of the stream.

Error Codes

StreamManager::ESOURCE_FCM—the FCM indicated by source does not exist
StreamManager::ESINK_FCM—the FCM indicated by sink does not exist

1StreamManager::ESOURCE_PLUG—the FCM indicated by source does not contain the specified plug
StreamManager::ESINK PLUG—the FCM indicated by sink does not contain the specified plug
StreamManager::EUNSUP_STREAM—connection requires an unsupported stream type
StreamManager::ENO_MATCH_STREAM—the plugs are incompatible (stream type mismatch)
StreamManager::ENO_MATCH_BW—the source bandwidth exceeds that supported by the sink or hint.Stype.maxBW exceeds supported Stype.maxBW of source/sink FCM (bandwidth mismatch)
StreamManager::ENO_MATCH_SPEED—the source uses a transmission speed unsupported by the sink
StreamManager::ENO_MATCH_DIR—the plugs are incompatible (direction mismatch)
StreamManager::ESOURCE_BUSY—the source plug is a member of another stream
StreamManager::ESINK_BUSY—the sink plug is a member of another stream
StreamManager::EDEV_BUSY—failure to allocate a device plug
StreamManager::EINSUFF_BANDWIDTH—bandwidth allocation has failed
StreamManager::EINSUFF_CHANNEL—channel allocation has failed
StreamManager::ESTATICBW—dynamicBw has the value False, the stream type is variable rate, but the source cannot be set to static bandwidth allocation
StreamManager::ERESERVED_SOURCE—required connection need to be established (i.e., not overlay) and rejected due to reservation protection.
StreamManager::ERESERVED_SINK—the FCM indicated by sink is reserved (and not by the software element making the FlowTo request)
StreamManager::EDEV_CONN—failure to establish a device connection
StreamManager::ESHARE—the connection cannot be established because the source plug is not sharable (and the owner differs from the software element making the FlowTo request)
   (b) StreamManager::OnThePath

Prototype

Status StreamManager::OnThePath(

in boolean dynamicBw,
in FcmPlug source,
in FcmPlug sink,
in StreamType streamType,
in TransportType segmentTransportType,
in TransmissionFormat segmentTransmissionFormat,
in Channel segmentChannel,
in ConnectionId connId)

Parameters
dynamicBw—indicates whether dynamic (dynamicBw is True) or static (dynamicBw is False) bandwidth allocation should be set.
source—a FcmPlug structure identifying the source plug.
sink—a FcmPlug structure identifying the sink plug.
streamType—the stream type of the connection. The stream type is unique over the whole connection, while the transport type, transmission format and channel can be different (especially when crossing various medium technologies.
segmentTransportType, segmentTransmissionFormat, segmentChannel—the values for the transport type, transmission format and channel of the current segment, i.e. the cluster the portal receiving this call is attached to.
connId—the ConnectionId value assigned by the initial Stream Manager.
   Description

This API is used between Stream Managers in bridges to build the connection across at least one cluster. The dynamicBw, source and sink parameters are copied from the original MultiClusterFlowTo method call. They are used by the Stream Managers of portals to determine to which portals on the path they need to send the stream.

The streamType parameter identifies the type of the stream. This type is unique for the whole stream, as it is not influenced by the transport used to carry the stream. A stream changing its stream type (e.g. from DV to MPEG2) will go through a converter (e.g. FCM converter) and in fact there will be two streams running, the FCM converter being the sink for the first stream and the source for the converted stream.

The “segment” parameters (segmentTransportType, segmentTransmissionFormat and segmentChannel) identify the parameters used on the current (i.e. local to the targeted Stream Manager) segment of the stream. This is useful for the Stream Manager of the portal receiving this call to obtain all the information on the connection established on its segment, to connect it internally to its co-portal.

The connId parameter is filled in by the initial Stream Manager, and it is used by portal Stream Managers on the stream path to “attach” their segment stream to the multi-clustered stream.

Error Codes

StreamManager::EUNSUP_TRANSPORT—connection requires an unsupported transport type
StreamManager::EUNSUP_STREAM—connection requires an unsupported stream type
StreamManager::ENO_MATCH_FMT—the plugs are incompatible (transmission format mismatch)
StreamManager::ENO_MATCH_SPEED—the source uses a transmission speed unsupported by the sink
StreamManager::ENO_MATCH_TRANSPORT—the plugs are incompatible (transport type mismatch)
StreamManager::ENO_MATCH_DIR—the plugs are incompatible (direction mismatch)
StreamManager::ESOURCE_BUSY—the source plug is a member of another stream
StreamManager::ESINK_BUSY—the sink plug is a member of another stream
StreamManager::EDEV_BUSY—failure to allocate a device plug
StreamManager::EINSUFF_BANDWIDTH—bandwidth allocation has failed
StreamManager::EINSUFF_CHANNEL—channel allocation has failed
StreamManager::EDEV_CONN—failure to establish a device connection

The process for setting up a multi-clustered stream connection is as follows:

A multi-clustered stream will be initiated by the Stream Manager local to the client, and owned by it, as in HAVi-1.1 (“own” is in the sense of present in its Local Connection Map). This Stream Manager will be named the “initial” Stream Manager. It forwards the call to the Stream Manager of the nearest portal of the targeted functional component (the device) on the path to the sink device. Consequently, the Stream Manager of a portal can receive local calls (by local clients) and remote calls (by remote Stream Managers).

This portal's Stream Manager is in charge of making the connection on the cluster with the targeted source functional component, and the Stream Manager of its co-portal the connection on the next cluster on the stream path. If the stream crosses other bridges, the co-portal Stream Manager will then send a HAVi message to the Stream Manager of the next bridge on the stream path, with all necessary information, so that this next bridge Stream Manager can forward the connection internally to its co-portal, which will make the connection on its cluster, etc. On each segment, the appropriate Stream Manager will call APIs of DCMs to perform the choice of transport parameters, those DCMs can be the ones of the source and sink devices, but also of the bridges on the path.

So the process is:
1. The client calls the MultiClusterFlowTo API of its local Stream Manager, named the initial Stream Manager.
2. The initial Stream Manager looks at the source functional component (the device, not the FCM) and forwards the call to the first portal connected to the source cluster on the path to the sink. This portal will be named the primary portal. Two possibilities, but no difference in behaviour:
The source functional component is on a remote cluster, forward the MultiClusterFlowTo call to the Stream Manager of the nearest portal connected to it (known with the nearestPortalGuid parameter in the NetDeviceInfo structure provided by the Network Manager).
The source functional component is on the local cluster, forward the MultiClusterFlowTo call to the Stream Manager of the local cluster portal on the path to the sink functional component device (the GUID of the sink device is on the remote list of this portal, and not in that of any other portal of the local cluster).
3. This Stream Manager on the primary portal performs all the DCMs and FCMs HAVi operations on stream type with the end points of the stream. Furthermore, it performs all the HAVi operations on transport for this cluster.
4. Then this Stream Manager is responsible for setting up the stream on the first segment, i.e. between the source device and the primary portal.
5. It then gives the hand to the Stream Manager of its co-portal.
6. This Stream Manager is responsible for setting up the stream on the second (or next) segment. It can be to the final sink device or to another portal. The transport of the stream on the segment is entirely decided and handled by this Stream Manager (including HAVi operations and DCMs/FCMs calls).
7. If another portal is on the path, the Stream Manager calls the StreamManager::OnThePath API of the Stream Manager residing in the next portal on the path to the sink device². Go to the step 5.

On specific clusters, the building of the connection may involve Stream Managers of both source and sink end points (portal or device).

The process diagram is as illustrated by FIG. 10.

For multi-clustered stream connection removal, there is no need for a new API. Any SE wanting to drop a running stream will call the Drop API of the Stream Manager which owns the stream. If it is a multi-clustered stream, this initial Stream Manager will forward this call to the first portal on the stream path, and the removal process is identical to the building process, based on the ConnectionId that every portal Stream Manager has kept internally as identifier for the connection on the cluster it is responsible for.

With this solution, a HAVi-1.1 device cannot drop a stream established by a remote Stream Manager, because it does not even see it. It may be able to drop a multi-clustered stream owned by a Stream Manager on its cluster (even if it does not understand the source and/or sink for this stream).

As a variant, the connection establishment could be done not from the source to the sink, but from the sink to the source.

The dynamic bandwidth allocation can still be managed on multi-clustered streams. If the dynamicBw boolean parameter is set to True in the MultiClusterFlowTo API, then the DCM source is responsible for reallocating the resource on its cluster. It then sends the BandwidthRequirementChanged event. This event is caught by the Stream Manager responsible for the next segment on the path. This Stream Manager reallocates bandwidth if required etc. If the dynamicBw boolean parameter is set to False in the MultiClusterFlowTo API, then a change in the required bandwidth for the stream may put the stream in failure mode (as described in HAVi-1.1).
²Je suppose que c'est le portal du mm cluster qui est appelé, puisque ce portal passe la main a son co-portal au retour á l'étape 5 OUI mais la portal et brigde identifient un autre device, c'est tout.

Stream connection error handling is carried out as follows: When a connection cannot be established on one segment during the building process, the Stream Manager will send back the OnThePath message with the failure reason in the Status return value. The connection is then removed, segment by segment up to the initial Stream Manager, which warns its client, or takes an “alternative path” if available (see below).

When an existing connection is cut on a segment (because of a Bus reset, a lack of resources, etc . . . ), the Stream Manager on this segment responsible for the connection sends a MultiClusterConnectionDropped event caught by the initial Stream Manager, and this one is responsible for dropping the stream, or trying to keep it alive through an “alternative path”. The initial Stream Manager is retrievable through the connId parameter of the OnThePath API. This connId parameter gives access to the mgr parameter, which is the SEID of the initial Stream Manager.

Encapsulation vs. Translation

According to the present embodiment, if a stream goes from a cluster based on medium technology A across a cluster based on medium technology B and back to a cluster based on medium technology A, the Stream Managers on the B type cluster decide not to translate the transport type of the stream (e.g. 1394 over IP). The stream will then be encapsulated on the cluster B. This can be useful for performance reasons. But as soon as a sink device is added to this stream on the cluster B, the stream will be translated, so that the renderer on medium technology B can display the stream. So then a A->B translation will be done for cluster B, and then a B->A translation for the target A type cluster.

The Stream Manager can provide the list of all HAVi streams running on the HAVi network, using so-called connection maps. This is done with the GetGlobalConnectionMap API. It works in a way similar to that of the Registry::GetElement. As before, due to the loop resolution process defined by the Network Managers, there is a need for a new parameter to forward this query to the Stream Managers of other clusters, in order to reduce traffic. The proposed API is:

Status StreamManager::ForwardGetGlobalConnectionMap(

in SEID initialRequester,
out sequence<Connection> list)

The initialRequester parameter allows a portal to know whether it has to forward this request to its co-portal or not. The local connection maps of each Stream Manager are gathered by the portal Stream Managers, and are finally sent back to the initial requesting Stream Manager.

According to the present embodiment, the Stream Manager of a bridge receiving the GetLocalConnectionMap from a device on its cluster acts differently depending on the caller's identity as derived from its SEID:

The caller is not a Stream Manager. This means that a SE wants to know its local connection map. The local connection map only is sent in reply.

The caller is a Stream Manager in a HAVi-1.1 device (i.e. non bridge aware). Again, only the local connection map is sent in reply.

The caller is a Stream Manager in a BA-device. The request is forwarded to the co-portal (if forwarding rules are fulfilled), and the co-portal Stream Manager will send a GetLocalConnectionMap to all the Stream Managers of its cluster and a ForwardGetGlobalConnectionMap to the Stream Managers of the other portals connected to its cluster.

Furthermore, a small modification is made in the Connection data structure, to handle the new multi-clustered connection. A new entry is added in the ConnectionType enumerated:
enum ConnectionType {FLOW, SPRAY, TAP, MULTI_CLUSTER_FLOW};

And in the case of a MULTI_CLUSTER_FLOW connection type, the transmissionFormat and channel parameters of the Connection structure will be set according to the source device (so in fact will only reflect the stream on the first segment, between the source and the first portal on the path).

The need of identification of the connection on each segment, with a segmented parameter copied from the connectionId structure (the mgr field identifying the Stream Manager responsible for the stream on the specified cluster), is to be studied.

According to the present embodiment, alternative paths are provided in certain conditions, as compared to the main path defined in the loop resolution process.

In case a stream cannot be established because of a lack of resources on one cluster on the path, and provided that another route is possible between the source and the sink not going through this cluster, the Stream Managers and the Network Managers may decide to reroute the stream over an alternative path to avoid the traffic-jammed cluster. This can apply for routes having the same number of hops as the original route, but may apply also to routes with a higher number of hops. In this case, the Network Managers have to keep track internally that they can reach devices that are currently on other portals' remote lists, so that the right paths may be chosen.

The FIG. 11 shows an example of using an alternative path. The cluster 1101 on the right side is already active with a stream that has unfortunately reserved nearly all the resources of that cluster (bandwidth or channel or both). A HAVi application wants to build a stream between the device 3 and the device 4. With the basic remote GUID lists in the Network Managers, this won't work because the stream will be established via the cluster 1101, so it will fail. Once the failure is known, the Stream Managers decides to use an alternative path for this stream, going through the cluster on the left side, which has the resources to carry it on. It is even possible to send the stream up to the device 13 through its co-portal 14.

The following process is used in the present case of an alternative path decision:
1. Stream establishment not possible on a segment (cluster) during building of the connection.
2. Bridge before cluster is warned (error returned for OnThePath call).
3. Bridge checks if another path exists.
4. If not found, error returned to the bridge before for the OnThePath call.
5. Go to step 3.³

(h) Resource Manager

The resource manager should not be affected by the bridges.

II] The HAVi Bridge-Aware Device

FIG. 12 represents the internal software architecture of a bridge-aware device (called BA-device in the rest of the description) according to the present embodiment. The BA-device comprises the HAVi 1.1. Software Elements plus an Sdd Manager and a Network Manager.
Sdd Manager

As already presented in the section devoted to the bridge device, the Sdd Manager of a BA-device will be in charge of retrieving the SDD data of any device on the entire HAVi network. This will be done accessing remote Sdd Managers or performing local low-levels calls.
CMM

There is basically no change in the CMM for a HAVi-BA-device. The CMM is responsible for enabling access to the low-level local cluster. So the CMM still provides a GetGuidList API, giving back the list of all GUIDs on the local cluster. And it provides a way to send/receive low-level messages on this cluster. Actually, the CMM1394 is specified in the HAVi-1.1 document.

Network Manager

The Network Manager of a BA-device acts as follows:
After cluster reconfiguration, it performs local discovery.
If it detects new bridges, it requests their respective remote lists.
When receiving a ENOT_READY error response, it waits for some time to receive the RemoteNetworkUpdated event.
If the event does not come after a specific amount of time, it may try again to obtain the remote list of the portals which did not answer.
When it has all the responses from the portals, it compares the lists to build its new list and to fill the changed, gone and new fields.
When its network device list is done, it sends the NetworkUpdated event to its clients.
During the time it is building its new list, any client request to obtain the network device list is answered with the ENOT_READY error.

III] New HAVi Values

New HAVi Software Element Types in addition to those existing in HAVi 1.1. are defined below.

TABLE 11

| | ATT_SE_TYPE | | System |
|---|---|---|---|
| HAVi Software Element Type | Value | Trusted | Element |
| SDD_MANAGER | 0x0000 0007 | yes | yes |
| NETWORK_DEVICE_{—} | 0x0000 0008 | yes | yes |
| MANAGER | | | |

HAVi SEIDs according to the present embodiment are as follows:

TABLE 12

| | Software Element |
|---|---|
| HAVi Software Element Type | Handle |
| SDD_MANAGER | 0x0007 |
| NETWORK_DEVICE_MANAGER | 0x0008 |
| COMMUNICATION_MEDIA_MANAGER_IP | 0x0009 |

HAVi API Codes are as follows.

TABLE 13

| HAVi API Name | API Code |
|---|---|
| SddManager | 0x0017 |
| NetworkManager | 0x0018 |
| CmmIp | 0x0019 |

Additional HAVi Operation codes for the Registry, the StreamManager, the SddManager and the CMMIP are as follows, according to the present embodiment:

TABLE 14

| | | Opera- |
|---|---|---|
| HAVi Message | API Code | tion ID |
| Registry::ForwardGetElement | 0x0003 | 0x05 |
| Registry::ForwardMultipleGetElement | 0x0003 | 0x06 |
| StreamManager::MultiClusterFlowTo | 0x0008 | 0x08 |
| StreamManager::OnThePath | 0x0008 | 0x09 |
| StreamManager::ForwardGetGlobalConnectionMap | 0x0008 | 0x0a |
| SddManager::GetSddData | 0x0017 | 0x00 |
| NetworkManager::GetNetDeviceList | 0x0018 | 0x00 |
| NetworkManager::GetNetDeviceInfo | 0x0018 | 0x01 |
| NetworkManager::GetRemoteDeviceList | 0x0018 | 0x02 |
| CmmIp::GetGuidList | 0x0019 | 0x00 |
| CmmIp::GetIpAddress | 0x0019 | 0x01 |
| CmmIp::GetGuid | 0x0019 | 0x02 |
| CmmIp::Send | 0x0019 | 0x03 |
| CmmIp::EnrollIndication | 0x0019 | 0x04 |
| CmmIp::DropIndication | 0x0019 | 0x05 |

HAVi Error Codes for the SddManager and the NetworkManager according to the present embodiment are as follows:

TABLE 15

| HAVi Error Name | API Code | Error Code |
|---|---|---|
| SddManager::ENOT_READY | 0x0017 | 0x0080 |
| SddManager::EUNKNOWN_GUID | 0x0017 | 0x0081 |
| SddManager::ELAV | 0x0017 | 0x0082 |
| NetworkManager::ENOT_READY | 0x0018 | 0x0080 |
| NetworkManager::EUNKNOWN_GUID | 0x0018 | 0x0081 |
| CmmIp::ENOT_READY | 0x0019 | 0x0080 |
| CmmIp::EUNKNOWN_GUID | 0x0019 | 0x0081 |
| CmmIp::EUNKNOWN_IP_ADDRESS | 0x0019 | 0x0082 |
| CmmIp::ESIZE | 0x0019 | 0x0083 |
| CmmIp::ENOT_FOUND | 0x0019 | 0x0084 |

HAVI System Event Types according to the present embodiment are as follows:

| | | | Base |
|---|---|---|---|
| | | Distri- | Event |
| HAVi System Event Type | Posted By | bution | Number |
| MultiClusterConnectionDropped | Stream Manager | global | 0x001c |
| SddDataChanged | SDD Manager | global | 0x0025 |
| NetworkUpdated | Network Manager | local | 0x0026 |
| RemoteNetworkUpdated | Network Manager | global | 0x0027 |
| RemoteNetworkChanged | Network Manager | global | 0x0028 |
| NewDevices | Communication | local | 0x0029 |
| | Media Manager IP | | |
| GoneDevices | Communication | local | 0x002a |
| | Media Manager IP | | |
| ChangedDevices | Communication | local | 0x002b |
| | Media Manager IP | | |
| GuidListReady | Communication | local | 0x002c |
| | Media Manager IP | | |
| ProxyGuidCreated | Communication | global | 0x002d |
| | Media Manager IP | | |

IV] Discovery Scenarios

(a) Network Without Loops

FIG. 18 illustrates the interaction of Network Managers during a complete network building process. All devices are first turned off, and then turned on at the same time, so the discovery is made in parallel for each device. For the bridge Network Managers, the Local and the Remote list constitution is described.

In FIG. 13, the first local discovery process is shown, i.e. topology building on the IEEE1394 cluster and multicast announcement on the IP cluster. At the end of this first step, the Network Managers have their local devices in their internal table, as illustrated in FIG. 13.

Then the bridge devices check if their Network Managers have complete non-remote lists or incomplete non-remote lists. A non-remote list comprises the local list plus all remote lists of other portals connected to the cluster. If such a complete list exists in one portal, it is then given to the other side (the co-portal), which considers then its remote lists as complete. In FIG. 14, the Network Manager of the GUID 5 of the bridge AB sees that it is the only bridge on this device, so the bridge can update the remote list of the GUID 6, which becomes (1,2,5). Same for the bridge device BC, the Network Manager of the GUID 7 updating its remote list as (3,4,8).

In FIG. 15, the Network Managers of the bridge devices ask each other for remote lists of devices. The Network Managers of bridge devices can iteratively update their remote device list. In particular, the non-remote lists for portal 6 and portal 7 being complete once the requests have been answered, the remote lists of portals 5 and 8 can be updated.

In FIG. 16, the Network Managers of the BA-devices ask to each bridge device connected to their local cluster the remote device list, and build their global network list.

In FIG. 17, a client SE can ask its local Network Manager for the global list of devices on the entire network.

(b) Adding a New Device in a Network Without Loops

FIG. 18 shows the starting point, i.e. an existing network without loops. Only the remote lists are shown in the bridge Network Managers.

A new device with GUID 9 is added. This device is detected on the cluster it is connected to, via local discovery means (selfID, multicast . . . ). Once detected, this GUID is updated in the Network Manager of the co-portal of the bridge connected to it. This is shown in FIG. 19, the co-portal 7 updates its remote list with the newly connected GUID 9.

Then the updated portals send out a RemoteNetworkUpdated event to the other Network Managers (in BA-devices and in bridges). A bridge connected to this portal catches this event and updates its own co-portal remote list. In FIG. 20, the portal 6 catches the event from portal 7, and updates its co-portal 5.

The complete network is then updated. The GUID 9 is now known on all clusters.

(c) Network with Loop

As before all devices of the network depicted in the FIG. 21 are turned on more or less simultaneously. The first step is still the local discovery process, which creates the local lists.

In this configuration, no portal can have a complete non-remote list to give to its co-portal as a valid remote list. All portals see that they are not alone on their cluster, so they will first ask the other portals for their remote list before updating the remote list of their own co-portal (FIG. 22). And as there are no leaves in this topology, every portal will wait for the other ones.

As the portals cannot answer the GetRemoteDeviceList query, they send a ENOT_READY response error. When a Network Manager in a portal receives such an error, it knows that the portals connected to its cluster have not finished updating their remote list (e.g. they are waiting for other portals connected to their co-portal: this can happen with a very long single line network).

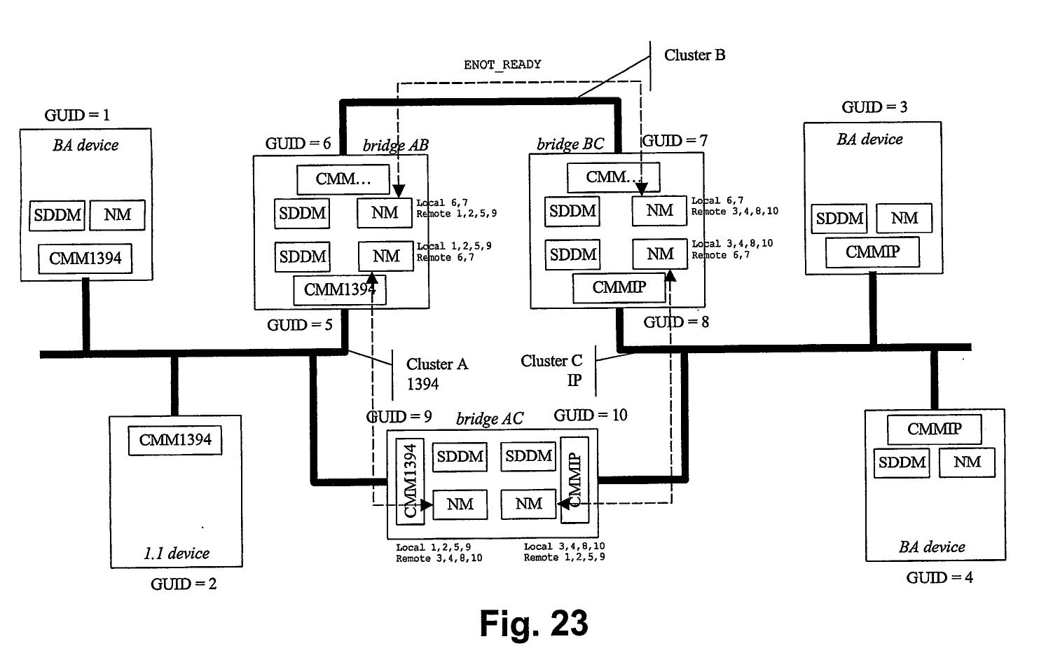

According to the present embodiment, the portal communicates to its co-portal an incomplete remote list. The co-portal then updates its remote list with this incomplete information. This is depicted in FIG. 23.

The portals then send out this incomplete remote list with the RemoteNetworkChanged event, as shown in FIG. 24. This event is for Network Managers of bridges only and specifies clearly that the list is not in a stable state (while RemoteNetworkUpdated is a final stable list).

1. Bridge device comprising at least two interfaces for interfacing respective clusters of network devices in a network wherein said bridge device comprises at least two interface portals for connecting clusters,
wherein the bridge device comprises for each portal a first software component for receiving from an internal client requests for device describing configuration memory data of at least one network device, said first software component being adapted to retrieve device describing data from other devices through a function call of a similar software component in the other devices.

2. Bridge device according to claim 1, wherein the first software component is adapted to retrieve data for a remote cluster device without similar software component through a function call to a similar software component of a bridge device on the path to the remote cluster device.

3. Bridge device according to claim 1, wherein the first software component is adapted to retrieve data for a device without similar software component on the same cluster as itself by issuing a medium dependent request message to the device.

4. Bridge device according to claim 1, wherein the first software component is adapted to maintain at least one of:
a. a list of identifiers of first software components of other devices on the network;
b. a list of devices devoid of similar first software components, associated with respective identifiers of the nearest portals on the paths to the devices in the list.

5. Bridge device according to claim 1, wherein the first software component is adapted to monitor changes in the device describing data of devices devoid of a first software component on its portals local cluster and to generate corresponding device describing data change events on the clusters connected to other portals of the bridge device.

6. Bridge device according to claim 1, further comprising for each portal a second software component for interfacing the portal's other software components of the respective portal with the portal cluster's communication medium, said second software component comprising an application programmable interface of which at least certain methods are globally accessible to software components of other devices of the network, for remotely accessing the communication medium.

7. Bridge device according to claim 6, wherein the globally accessible methods comprise at least one among write, read, lock, enroll, drop, indication.

8. Bridge device according to claim 1, further comprising for each portal a third software component for maintaining a list of all devices on all clusters of the network.

9. Bridge device according to claim 8, wherein the third software component is adapted to generate, upon detection of a change on any cluster of the network, a first event informing software components of its portal of the nature of the change.

10. Bridge device according to claim 8, wherein the third software component is adapted to generate a second event for informing the third software components of other portals only of the state of the event issuing portal's a remote device list.

11. Bridge device according to claim 10, wherein the second event comprises a potentially incomplete list of remote devices compared to the event-issuing portal, i.e. devices reachable through the co-portals of the event issuing portal.

12. Bridge device according to claim 8, wherein the third software component is adapted to generate a third event for informing the third software components of all devices on the cluster that the hosting portal's remote device list is stable.

13. Bridge device according to claim 12, wherein the third event comprises a complete list of remote devices compared to the event-issuing portal, i.e. devices reachable through the co-portals of the event-issuing portal.

14. Bridge device according to claim 1, wherein each portal comprises a fourth software component for forwarding to co-portals event messages detected on a portal's local cluster.

15. Bridge device according to claim 1, wherein each portal comprises a fifth software component for receiving, on one of the bridge's clusters, a request from a fifth software component of another device, and means for forwarding said request to fifth software elements on its other clusters, with the initial requester's identifier as source address, and for forwarding the non-concatenated responses to this request back to initial requesting device.

16. Bridge device according to claim 1, wherein each portal comprises a fifth software component for receiving, on one of the bridge's clusters, a request from a fifth software component of another device, and means for forwarding said request to fifth software elements on its other clusters, wherein the forwarded request contains as a parameter the address of the forwarding portal, for receiving and concatenating responses to the forwarded request and for forwarding the concatenated responses to this request back to the initial requesting device.

17. Bridge device according to claim 16, wherein said means for forwarding said request are adapted to use a first message type for forwarding the request to fifth software elements of bridge devices and a second message type for forwarding the request to fifth software elements of non bridge devices, wherein the identifier of the forwarding portal is a parameter in the first message and not in the second message¹.

18. Bridge device according to claim 1, wherein each portal comprises a fifth software component for receiving, on one of the bridge's clusters, a request from a fifth software component of another device, and means for forwarding said request with the initial requester's identifier as source address to fifth software elements on its other clusters, for intercepting responses to this forwarded request, for concatenating the contents of these responses and for sending a single concatenated response to the initial request back to the initial requesting device.

19. Bridge device according to claim 1, further comprising means for converting the transport type of packets between the communication mediums of its clusters.

20. Bridge device according to claim 1, wherein each portal comprises a sixth software element for establishing connection segments on local clusters for a connection crossing the bridge upon reception of a connection establishment request from a sixth software element of another device.

21. Bridge device according to claim 20, wherein the sixth software element of a portal is adapted to establish a connection on its local cluster and of its local cluster to carry out the next segment establishment on the path to a connection end device.

22. Device for connection to a cluster in a multi-cluster network, wherein clusters are connected through bridge devices, each bridge device comprising at least two cluster interfaces, wherein each interface is considered as a network device on its respective cluster wherein the network device comprises a first software component for receiving from an internal client requests for device describing configuration memory data of at least a second device, said first software component being adapted to retrieve device describing data from the at least one other device through a function call of a similar software component in the at least one device.

23. Device according to claim 22, wherein the first software component is adapted to retrieve data for a remote cluster device without similar software component through a function call to a similar software component of a bridge device on the path to the remote cluster device.

24. Device according to claim 22, wherein the first software component is adapted to retrieve data for a second device without similar software component on the same cluster as itself by issuing a medium dependent request message to the second device.

25. Device according to claim 22, wherein the first software component is adapted to maintain at least one of:
a list of identifiers of first software components of other devices on the network;
a list of devices devoid of similar first software components, associated with respective identifiers of the nearest portals on the paths to the devices in the list.

26. Device according to claim 22, further comprising a third software component for maintaining a list of all devices on all clusters of the network, wherein said third software component comprises means for retrieving remote device lists from portals connected to its local cluster, and for concatenating the remote device lists with a local cluster device list.

27. Device according to claim 26, wherein the third software component is further adapted to maintain in the network device list an indication of the closest portal on the path for a remote device compared to the device's own local cluster.

28. Device according to claim 25, wherein the third software component is adapted to generate, upon detection of a change on any cluster of the network, a first event informing components of its local device of the nature of the change.

29. Device according to claim 22, comprising a fifth software component for receiving from a local client, a request for a list of remote software elements and for forwarding said request to fifth software elements of devices of the local cluster only.

30. Device according to claim 22 comprising a sixth software element including an application programmable interface for clients of the same device, adapted to receive a request for establishing a connection between a sink device and a source device, said sixth software element being adapted to determine, on the path between the source and the sink device, the portal closest to the source device on the path to the sink device, and for sending an appropriate request to that portal for establishing the connection on its local clusters and for propagating this request to other appropriate portals on the path.

31. Method for discovering devices in a network comprising at least two device clusters and at least one bridge, wherein at least two clusters are connected by a bridge, each bridge comprising at least two interface portals for connection to respective clusters, said process comprising the steps of:
having each portal obtain a list of identifiers (GUID) of its local cluster's devices;
having each portal request remote device lists from each portal of the same cluster as itself;
having each portal build its own remote device list by requesting from its co-portals the list of their local devices and of remote devices reachable through the co-portals.

32. Method according to claim 31, further comprising the step of making a bridge passing to messages destined to a given device if it is on the shortest path to that device.

33. Method according to claim 32, wherein the shortest path is the path with the lowest number of portals to be crossed.

34. Method for establishing a connection between a source device and a sink device in a network comprising a plurality of device clusters connected by bridge devices, wherein each bridge device comprises interface portals for connection to clusters, said method comprising the steps of:
(a) providing stream manager software elements in portals of bridges and in other bridge aware devices of the network;
(b) receiving, at the level of a stream manager software element of a device, request from a connection from local client;
(c) identifying, on the path between the sink device and the source device, the portal closest to the source device, and sending a connection request to that portal;
(d) having the portal receiving the connection request establish a segment of the connection between the source device and the portal's bridge;
(e) having the portal receiving the connection request have the next portal of its bridge on the path to the source device establish the next segment of the connection on the next portal's local cluster;
(f) identify the next bridge, if any, on the path to the sink instruct the remote portal of the next bridge on the path to the sink device to establish the appropriate segment of the connection;
(g) go to step (e) until the segment of the connection to the sink device has been established.
